(19) United States
(12) Patent Application Publication
(10) Pub. No.: US 2025/0269213 A1
(43) Pub. Date: Aug. 28, 2025

(54) COMMUNITY FIRE MANAGEMENT METHODS AND SYSTEMS

(71) Applicant: Has LLC, Jackson, WY (US)

(72) Inventor: Harry Statter, Jackson, WY (US)

(73) Assignee: Has LLC, Jackson, WY (US)

(21) Appl. No.: 19/198,036

(22) Filed: May 3, 2025

Related U.S. Application Data
(63) Continuation-in-part of application No. 18/972,760, filed on Dec. 6, 2024.
(63) Continuation-in-part of application No. 18/798,451, filed on Aug. 8, 2024.
(63) Continuation-in-part of application No. 18/366,803, filed on Aug. 8, 2023.
Application No. 18/366,803 is a continuation-in-part of application No. 17/979,716, filed on Nov. 2, 2022.
(63) Continuation-in-part of application No. 17/875,966, filed on Jul. 28, 2022.
(60) Provisional application No. 63/607,030, filed on Dec. 6, 2023.
(60) Provisional application No. 63/680,993, filed on Aug. 8, 2024.
(60) Provisional application No. 63/518,309, filed on Aug. 8, 2023.
(60) Provisional application No. 63/493,734, filed on Apr. 1, 2023.
(60) Provisional application No. 63/421,949, filed on Nov. 2, 2022.
(60) Provisional application No. 63/397,891, filed on Aug. 14, 2022.
(60) Provisional application No. 63/396,162, filed on Aug. 8, 2022.
(60) Provisional application No. 63/274,900, filed on Nov. 2, 2021.
(60) Provisional application No. 63/226,730, filed on Jul. 28, 2021.

(51) Int. Cl. A62C 3/02; A62C 37/44

(52) U.S. Cl. CPC A62C 3/0214; A62C 3/0264; A62C 37/44

(57) ABSTRACT

There is provided a networked based coordinated wildfire management system for the protection of a community of structures from a wildfire. The systems have hydration plans that provide for the minimal use of water to protect the structures for the wildfire. The hydration plans can be automated adaptive hydration plans that the control system develops to address a specific wildfire threat, and these plans are developed in real time. The systems can have sprinkler towers that are place along roadway and near structures to implement the hydration plan and protect evaluation routes. The systems provide an integrated approach to protection an entire community.

This application is: (i) claims priority to, and under 35 U.S.C. § 119 (e) (1) the benefit of, U.S. provisional application Ser. No. 63/680,993 filed Aug. 8, 2024; (ii) a continuation-in-part of U.S. patent application Ser. No. 18/798,451 filed Aug. 8, 2024, which claims priority to, and under 35 U.S.C. § 119 (e) (1) the benefit of, U.S. provisional application Ser. No. 63/518,309 filed Aug. 8, 2023; (iii) a continuation-in-part of U.S. patent application Ser. No. 18/366,803 filed Aug. 8, 2023, which claims priority to, and under 35 U.S.C. § 119 (e) (1) the benefit of, U.S. provisional applications Ser. No. 63/493,734 filed Apr. 1, 2023, Ser. No. 63/421,949 filed Nov. 2, 2022, Ser. No. 63/397,891 filed Aug. 14, 2022, and serial number 63/396,162 filed Aug. 8, 2022; (iv) a continuation-in-part of U.S. application Ser. No. 17/979,716 filed Nov. 2, 2022, which application claims priority to, and under 35 U.S.C. § 119 (e) (1) the benefit of, U.S. provisional application Ser. No. 63/274,900 filed Nov. 2, 2021; (v) a continuation-in-part of U.S. application Ser. No. 17/875,966 filed Jul. 28, 2022, which application claims priority to, and under 35 U.S.C. § 119 (e) (1) the benefit of, U.S. provisional application Ser. No. 63/226,730 filed Jul. 28, 2021; and, (vi) a continuation-in-part of U.S. application Ser. No. 18/972,760 filed Dec. 6, 2024, which application claims priority to, and under 35 U.S.C. § 119 (e) (1) the benefit of, U.S. provisional application Ser. No. 63/607,030 filed Dec. 6, 2023, the entire disclosure of each of which is incorporated herein by reference.

### BACKGROUND OF THE INVENTION

### Field of the Invention

The present inventions relate to networks, control systems, and

multivariable component systems and activities for the management, mitigation, and suppression of wildfires.

The term “wildfire” as used herein, unless specified otherwise should be given its broadest possible meaning and would include any outdoor fire, and any fire that is located outside of a structure, this would include for example brush fires, forest fires, and grass fires. The term wildfire, however, as used herein, unless specified otherwise, would further include structure fires that were caused directly or indirectly by a wildfire.

As used herein, unless specified otherwise, the terms “external fire management system” (“EFMS”), “external fire suppression system”, “static fire protection system”, “fixed fire protection system”, “structure fire protection system” and similar such terms, should be given their broadest possible meaning, and would include systems that provide a fire suppressant medium (e.g., water) on the outside of structures, to the adjacent grounds and both. The adjacent grounds would include land area, vegetation, and materials located in contact with, adjacent to, near and around the structure, e.g., as far as about 10 feet, about 20 feet, and about 50 feet, from 10 feet to 30 feet, from 5 feet to 75 feet, or more from the exterior walls of the structure. These systems can for example provide water in the form of sprays, mists, streams, sheets and combinations and variations of these to the structures and adjacent grounds. The systems can provide fire suppressant foam to the outside of structures and to the adjacent grounds. These systems can provide combinations of water and foam. These systems can use a fire suppressant medium that is water, foam, or fire retardant and use combinations of two or three of these mediums, either simultaneously, alternatively, or in various patterns, including alternating patterns of use, as well as patterns of use designed to address a specific predetermined conduction (e.g., hydration levels of materials near a structure). These systems can, and typically do have, sensors and monitors, that provide data about the system, its activation, its rate of use of fire suppression medium (e.g., water or foam), the temperature(s) in and around the structure. It is understood that the exterior or outside of the structure includes one or more of the roof, exterior walls, outer surfaces of outside walls, gutters, garage doors, or any portion or part of the structure that is exposed to the outside environment, and thus likely to be exposed to the wildfire and embers. An example of a fixed fire protection system would be those provided by Frontline Fire Protection LLC., in Casper Wyoming.

As used herein, unless specified otherwise, the term “internal fire suppression system” and similar such terms, should be given its broadest possible meaning, and would include any automated sprinkler system or other fire suppression system that is located inside of a structure and configured to manage and suppress a fire that is inside of that structure. Typically, these internal fire suppression systems are static systems.

As used herein, unless specified otherwise, the terms “actual data”, “actual information”, “raw data”, “raw information”, and similar such terms are to be given their broadest possible meaning and would include information obtained from direct and indirect observation, monitoring, measuring, sensing and combinations and variations of these.

As used herein, unless specified otherwise, the terms “derived data”, “derived information” and similar such terms are to be given their broadest possible meaning and would include raw data upon which a calculation or operation has been performed.

As used herein, unless specified otherwise, the terms “predictive data”, “predictive information”, “determinative information” and “determinative data” are to be given there broadest possible meanings and would include derived data and information that provides, for example, information about trends, information leading to future outcome, future events, predicted events, trends leading to further events, normalized real time performance as an indicator of future actions or events, and similar mathematically derived and predictive values that are, or are at least in part based upon, derived data. Predictive data and information would include derived data in the form of probabilities of likely outcome, windows of likely outcome and similar types of values.

As used herein, unless specified otherwise the term “automated adaptive plan”, means instructions, plans or both that are developed or modified by the control system after the start of a wildfire event, and are based upon raw data, predictive data, derived data and combinations and variations of these and other information. Automated adaptive strategies are configured to respond to and protect from a specific wildfire event, as the risks from that event evolve and change over time.

Generally, the term “about” and the symbol “˜” as used herein, unless specified otherwise, is meant to encompass the greater of a variance or range of +10%, or the experimental or instrument error associated with obtaining the stated value.

As used herein, unless expressly stated otherwise terms such as “at least”, “greater than”, also mean “not less than”, i.e., such terms exclude lower values unless expressly stated otherwise.

As used herein, unless specified otherwise, the recitation of ranges of values, a range, from about “x” to about “y”, and similar such terms and quantifications, serve as merely shorthand methods of referring individually to separate values within the range. Thus, they include each item, feature, value, amount or quantity falling within that range. As used herein, unless specified otherwise, each and all individual points within a range are incorporated into this specification, and are a part of this specification, as if they were individually recited herein.

This Background of the Invention section is intended to introduce various aspects of the art, which may be associated with embodiments of the present inventions. Thus, the foregoing discussion in this section provides a framework for better understanding the present inventions, and is not, and should not be viewed as, an admission of prior art.

### SUMMARY

There has been a long standing, ever increasing need for systems, networks and methods that can integrate and control methods and systems for wildfire mitigation, management and suppression. The present inventions meet these and other needs.

There is provided a coordinated wildfire management system for the protection of a community of structures, the system having: a plurality of external fire management systems (EFMSs); a plurality of structures; wherein the plurality of structures are located near one another and thereby define an area for the community of structures; wherein more than half of the structures have an EFMS; wherein the plurality of EFMSs is in control communication with a network and thereby forms a node on the network; a monitoring device in communication with the network, and thereby forming a node on the network; wherein the monitoring device can monitor a wildfire event and provide information about the wildfire event to the network; and, a control system in control communication with the network, the control system includes a graphic user interface, a processor and a memory device; wherein each of the EFMSs is in control communication with the control system; the control system having a hydration plan and configured to implement the hydration plan; wherein the hydration plan provides for using a minimum amount of water needed to protect the area from a wildfire threat; thereby preventing the ignition of the structures.

Additionally, there is provided these systems having one or more of the following features: wherein the hydration plan includes: providing less than 1 inch of water per 24 hour period to a home ignition zone; wherein the home ignition zone is adjacent to at least one of the structures and extends out from the structure by about 5 feet to 30 feet; wherein all of the structures in the plurality of structures has an EFMS and a water supply line; and wherein the EFMSs have an infeed line that provides a source of water from the water supply line; wherein the EFMSs are not connected to, and do not use a municipal fire hydrant system as a source of water; wherein the hydration plan includes: providing a sufficient amount of water over a predetermined time period to a home ignition zone to maintain a level of hydration in the home ignition zone at a fuel moisture content that is from about 100 percent to about 300% during the predetermined time period; wherein the home ignition zone is adjacent to at least one of the structures and extends out from the structure from about 5 feet to 30 feet; wherein at least 90 percent of the structures in the plurality of structures has an EFMS; further having: a sprinkler tower system; wherein the sprinkler tower system is located near a roadway in the community and at least one of the structures in the community; wherein the sprinkler tower system provides a zone of protection; whereby the zone of protection includes both a portion of the roadway and a portion of one or more of the structures; whereby the sprinkler tower system provides protection from wildfires to both the roadway thereby providing a safe evaluation route and to the portion of the structure; further having a plurality of sprinkler tower systems; wherein the sprinkler tower systems are in control communication with the control system; and, delivery of water from the sprinkler tower systems is a part of the hydration plan; and, wherein one or more of the EFMSs, the sprinkler tower system or both, have an additional water supply means; wherein the additional water supply means includes a pumper truck.

Moreover, there is provided these systems having one or more of the following features: wherein the hydration plan includes: providing a sufficient amount of water over a predetermined time period to the area of the community to maintain a level of hydration in the area at least 10% of a hydration level during the predetermined time period; wherein the hydration level is based upon soil percentage water content by weight; wherein the hydration level is defined as a level sufficient to maintain an ignition point of the structures, fuel sources in the community or both above the energy from an ember attack, a wildfire or both; thereby preventing ignition of the structures, the fuel sources in the community or both during the predetermined time period.

Still further there is provided a coordinated wildfire management system for the protection of a community of structures, the system having: a plurality of structures; wherein the plurality of structures are located near one another and thereby define an area for the community of structures; wherein more than 75 percent of the structures have an external fire management systems (EFMSs); a network having a monitoring and control system; wherein the monitoring and control system includes a graphic user interface, a processor and a memory device; wherein the EFMSs are in control communication with the monitoring and control system via the network; and, the monitoring and control system is configured to: determine a risk of a wildfire to the community, thereby providing a determined risk of the wildfire to the community; determine a hydration plan based upon the determined risk of the wildfire to the community of structures and an available amount of water for the system and thereby providing an automated adaptive hydration plan; and, wherein the automated adaptive hydration plan provides for using no more than the available amount of water to protect the community of structures from the determined risk of the wildfire to the community.

Furthermore, there is provided these systems having one or more of the following features: wherein the determined risk of the wildfire to the community includes a time period for embers from the wildfire, the wildfire or both to reach the community; wherein the time period further includes a time for the wildfire to pass by the community; wherein: the available amount of water is defined as: a flow rate (F_{w}); and, and total volume of water (V_{w}); the determined risk of the wildfire to the community includes a time period (Tᵣ); and the hydration plan includes: the system delivering water to the area of the community at one or more locations in the area; the delivery of water to the one or more locations being at one or more intervals (I) for each of the locations during the time period Tᵣ; wherein each interval (i) has a predetermined duration defined by an interval time (Iₜ); and, the delivery of water during each interval (I) is at a predetermined flow rate (IFᵣ); whereby the hydration plan delivers a total volume of water (HV_{w}) during time period (Tᵣ); wherein IFᵣ does not exceed F_{w}; and HV_{w} does not exceed V_{w}; thereby the structures, fuel sources in the community or both are maintained at an ignition point above the energy from an ember attack, the wildfire or both; thereby preventing ignition of the structures, the fuel sources in the community or both during the time period Tᵣ.

Still further there is provided these systems having one or more of the following features: wherein time period Tᵣ includes a time period for embers from the wildfire, the wildfire or both to reach the community; wherein the time period Tᵣ further includes a time for the wildfire to pass by the community; wherein for at least the majority of intervals (I) the interval time (Iₜ) is less than the time period Tᵣ.; and, wherein a total flow rate for all intervals (i) occurring at a same time does not exceed F_{w}, further having: a plurality of sprinkler tower systems located in the area for the community of structures; wherein one or more of the sprinkler tower systems is located near a roadway in the community, an open space in the community, or one of the structures; wherein one or more of the sprinkler tower systems is located near a roadway in the community and an open space in the community; wherein one or more of the sprinkler tower systems is located near a roadway in the community and a structure; or, wherein one or more of the sprinkler tower systems is located near a roadway in the community, a structure and an open space in the community; and, wherein the sprinkler towers are in control communication with the network; and delivery of water from the sprinkler tower systems is a part of the hydration plan.

### BRIEF DESCRIPTION OF THE DRAWINGS

FIG. 1A is a schematic of an embodiment of an emergency network configuration and communication system in accordance with the present inventions.

FIG. 1B is a detailed schematic of an embodiment of a data processing assembly of the system of FIG. 1A, in accordance with the present inventions.

FIG. 2 is a schematic of an embodiment of a EFMS in accordance with the present inventions, which can form a node on embodiments of an emergency communications systems in accordance with the present inventions.

FIG. 3 is a schematic plan view of an embodiment of an EFMS, which can form a node on embodiments of an emergency communications systems, such as the system of FIG. 1B, in accordance with the present inventions.

FIG. 4 is a schematic plan view of an embodiment of an EFMS, which can form a node on embodiments of an emergency communications system, such as the system of FIG. 1A, in accordance with the present inventions.

FIG. 5 is a schematic side view of an embodiment of an under eave distribution head configuration of an EFMS in accordance with the present inventions.

FIG. 6 is a flow diagram schematic view of an embodiment of an EMFS and its operation in accordance with the present inventions.

FIG. 7 is a schematic of an embodiment of an EFMS hydration system, plan and method in accordance with the present inventions.

FIG. 8 is a schematic of an embodiment of an EFMS hydration system, plan and method in accordance with the present inventions.

FIG. 9 is a schematic of an embodiment of an EFMS system in accordance with the present inventions.

FIG. 10 is a schematic of an embodiment of an EFMS system in accordance with the present inventions.

FIG. 11 is a is a schematic flow chart of EFMSs and a network having a control command operation plan, including a community level protection plan, in accordance with the present inventions.

FIG. 12 is a schematic flow chart of EFMSs and a network having a control command operation plan in accordance with the present inventions.

FIG. 13 is a schematic flow chart of EFMSs and a network having a control command operation plan in accordance with the present inventions.

FIG. 14 is a schematic of an EFMS that is integrated with an existing landscape irrigation system in accordance with the present inventions.

FIG. 15 is a schematic of a community protected by EFMSs and a network in accordance with the present inventions.

FIG. 15A is a schematic of a community protected by EFMSs and a network in accordance with the present inventions.

FIG. 15B is a schematic of a community protected by EFMSs and a network in accordance with the present inventions.

FIG. 15C is a schematic of a community protected by EFMSs and a network in accordance with the present inventions.

FIG. 15D is a schematic of a community protected by EFMSs and a network in accordance with the present inventions.

### DESCRIPTION OF THE PREFERRED EMBODIMENTS

The present inventions, in general, relate to networks, systems and methods for mitigating, managing and address wildfires and risks of wildfire. In general, in embodiments of the present invention there is provided emergency management control network and system, having a control system, that is in control communication with one or more local controllers. In these embodiments, the control system, the local controller and both, have one or more operation control command plan for performing an operation plan. In embodiments, these operation plans can be, one or more of, a hydration plan, a lockout plan, a low line pressure plan, an adjacent structure based plan, and an auto-activation notice with default activation plan.

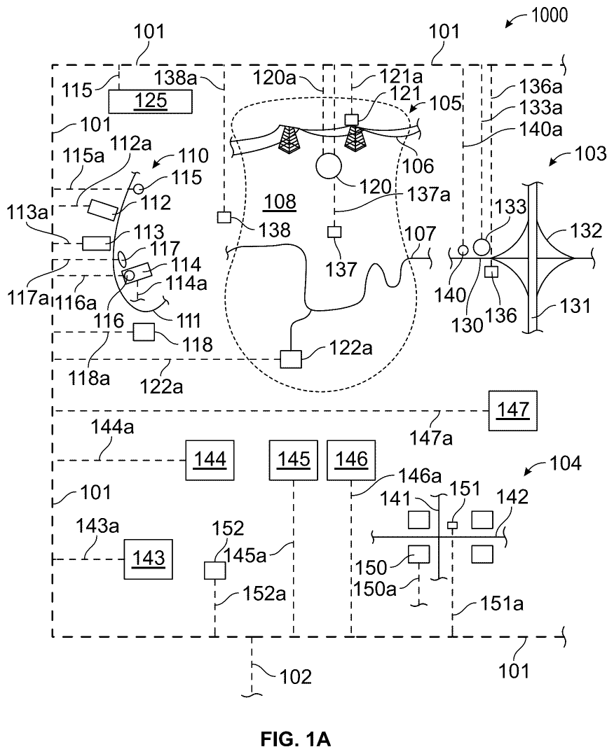

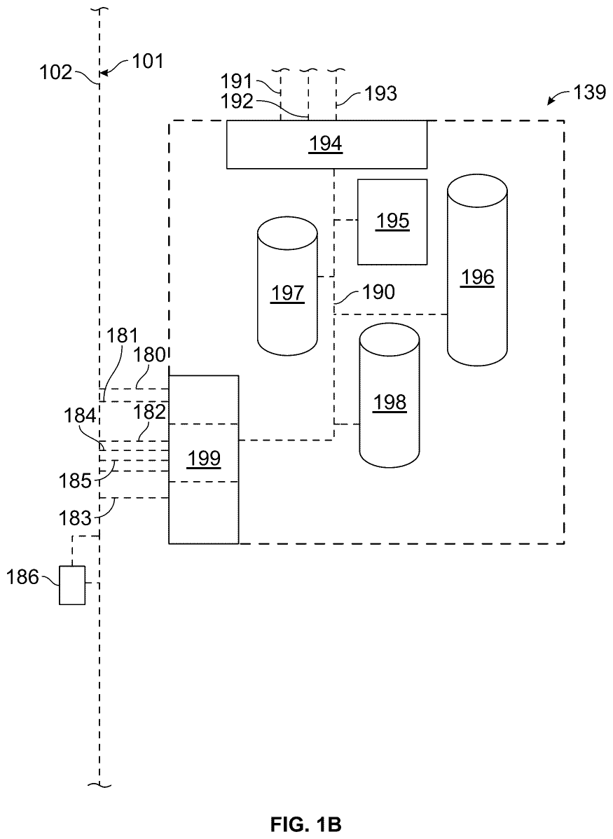

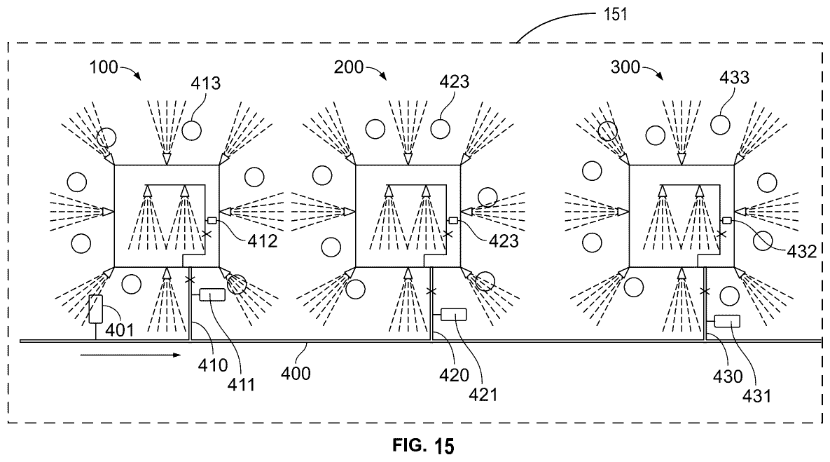

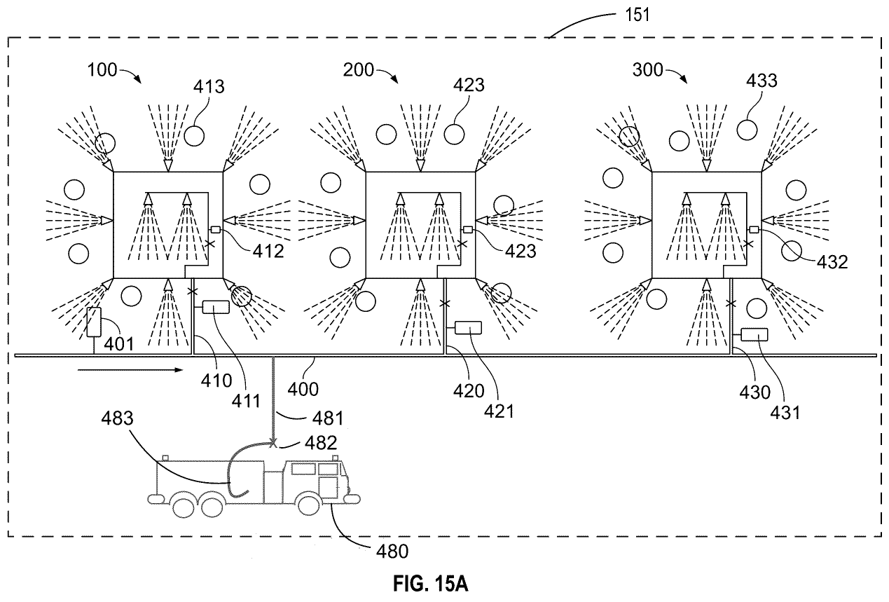

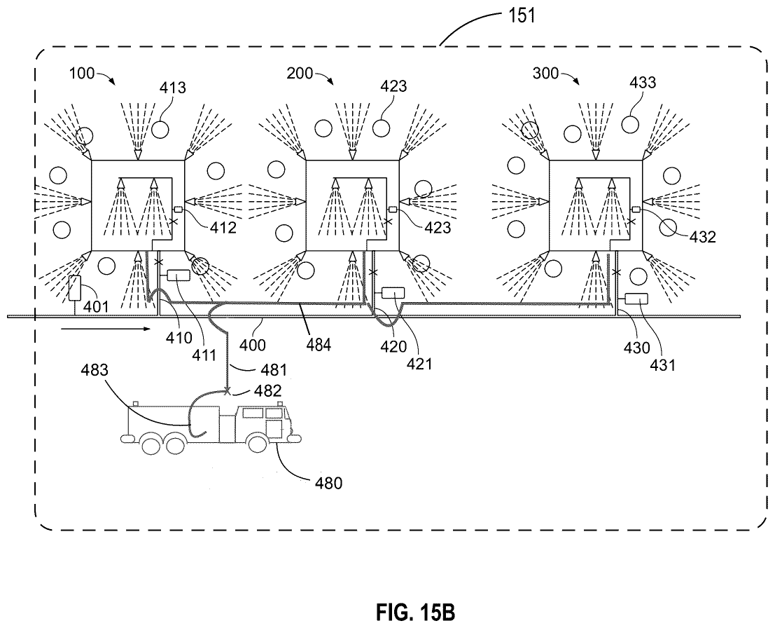

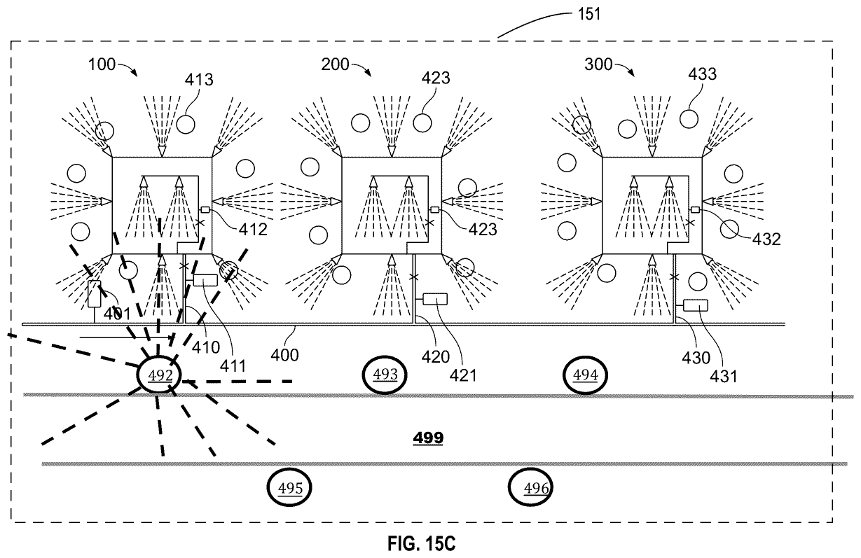

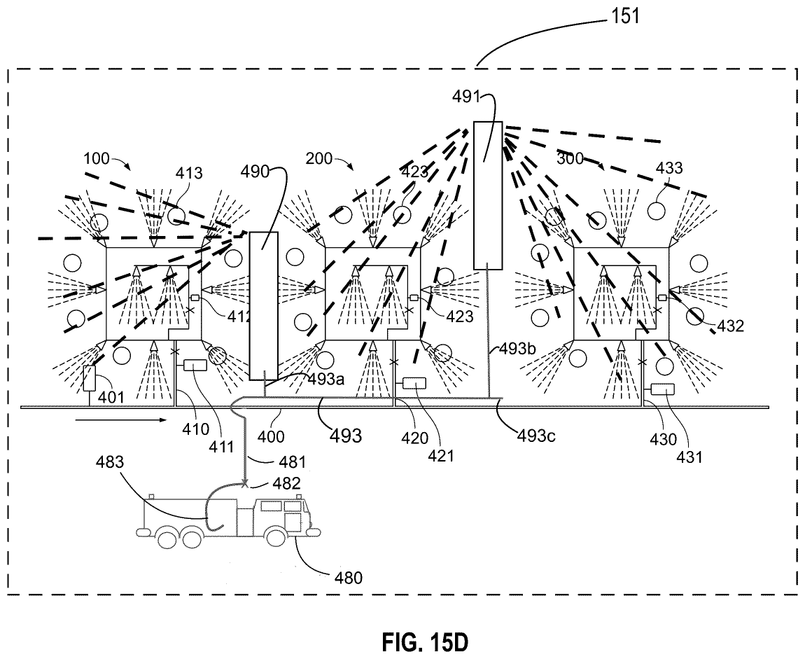

In general, embodiments of the present inventions relate to a coordinated wildfire management system for the protection of a community of structures, the system having a plurality of external fire management systems (EFMSs). Thus the coordinated wildfire management system, can include for example one or more of the embodiments of FIGS. 15, 15A, 15B, 15C, 15D, the entire area depicted in FIG. 1A, or just a collection of structures such as the structures along street 111 in FIG. 1A. Thus, the plurality of structures are located near one another and thereby define an area for the community of structures. Not all of the structures in the community (e.g., the defined area) need to have EFMSs, however there should be sufficient number of such systems, augmented by tower systems, if need be, to provide the necessary coverage and protection, and preferably to implement a hydration plan that utilizes the least amount of water needed to protect the community from an identified, and preferably a risk determined by the control system from a wildfire even.

In general, the EFMSs in the coordinated wildfire management system for the protection of a community of structures are in control communication with a network and thereby each forms a node on the network. The system has one or more monitoring and control devices forming a node on the network. These device are typically linked to an EFMS, and can also be linked to the control system that controls the protection of the community. The control system is in control communication with the network, and will include one or more graphic user interface, one or more processors and one or more memory devices. EFMSs and tower systems are in control communication with the control system.

The control system has a hydration plan, typically which is stored in its memory device, and is configured to implement that plan in response to a wild fire event, and preferably based upon a risk determined by the control system from the wildfire even. Preferably, the hydration plan provides for using a minimum amount of water needed to protect the community of structures from a wildfire threat and thereby preventing the ignition of the structures.

Still more preferably, the hydration plan can be an automated adaptive plan. In this manner the control system is configure to develop a hydration plan based upon information and data received during the wildfire event, modify an existing hydration plan based upon information and data received during the wildfire event and both. The received information and data can be any of the types of information and data set forth in this specification and would include for example hydration levels, available water (pressure, flow rate, volume), wind speed, ember detection, and location of the fire.

In general, these hydration plans that are developed and modified in response to a wildfire event as implemented by the control system can, for example: (i) provide less than 1 inch of water per 24 hour period to a home ignition zone, when the home ignition zone is adjacent to at least one of the structures and extends out from the structure by about 5 feet to 30 feet; (ii) provide a sufficient amount of water over a predetermined time period to a home ignition zone to maintain a level of hydration in the home ignition zone at a fuel moisture content that is from about 100 percent to about 300% during the predetermined time period, when the home ignition zone is adjacent to at least one of the structures and extends out from the structure from about 5 feet to 30 feet; (ii) provide a sufficient amount of water over a predetermined time period to the area of the community of structures to maintain a level of hydration in the area at least 10% of a hydration level during the predetermined time period, when the hydration level is based upon soil percentage water content by weight and is defined as a level sufficient to maintain an ignition point of the structures, fuel sources in the community or both above the energy from an ember attack, a wildfire or both; and combinations and variation of these. In this manner, the implementation of these hydration plans prevents ignition of the structures, the fuel sources in the community or both during the wild fire event.

In general, embodiments of the present inventions can have a monitoring and control system, which includes one or more graphic user interfaces, processors and a memory devices. The monitoring and control system is control communication via a network having EFMSs, sensors and monitors. The monitoring and control system is configured to, for example, determine a risk of a wildfire to the area, the community of structures or both, thereby providing a determined risk of the wildfire, and them determining, e.g., developing or modifying, a hydration plan based upon the determined risk of the wildfire to the community and an available amount of water for the system. In this manner the hydration plan, which would be an automated adaptive plan, provides for using no more than the available amount of water to protect the community from the determined risk of the wildfire to the community. In this manner, the automated adaptive hydration plan would be determined real time and thus adapt to changes in the wildfire threat in real time.

In general, embodiments of the present inventions relate to control systems, and preferably control systems that are at least in part cloud based for interfacing with and the management and coordination of multiple peripheral devices in conjunction with EFMS and internal fire suppression systems. In a preferred embodiment, these control systems are configured so that control and communication devices, such as a smart phone or tablet, can interface with, and have control communications with, a large number of different types of peripheral devices, from different manufactures, without the need for custom or proprietary communications protocols from the manufactures of the peripheral devices. Thus, embodiments of the present inventions are in general control systems that can communicate, preferably through remote control communication devices, with various peripheral devices, in particular such devices that are smart device, i.e., having internet, WiFi or other type of connectivity and their own control system, and then enter into control communication with the peripheral device's control system. In general, the present inventions relate to control systems that have connectivity capability to connect to a large number of different types of devices (e.g., smart devices, internet enabled device, device on or capable of being on the internet, etc.). The control system has the ability, preferably using one or more menus to provide for the easy connection of the device to the control system. In this manner the control system is placed in control communication with the peripheral device. Further, in this manner, the user can control and receive information from the device that is pertinent to a wildfire, a wildfire risk or other natural disasters. In general, these control systems can also, and preferable also preform the functions of the control systems described in the specification.

Embodiments of the present inventions relate to relate to networks, systems and methods for mitigating, managing and address wildfires and risks of wildfire that utilize and interface with components, including software, of irrigation system (e.g., agriculture watering system, lawn sprinklers, etc.) that are typically used for providing water to the land surrounding the structure as a part of the emergency management control network and system. Thus, in these embodiments the irrigation system components become a part of, or are used and controlled by, the external fire management system (EFMS), such as being controlled by the control system for the EFMS, the local controller for the EFMS, or both.

More particularly, in embodiments, the present inventions relate to emergency management control network and systems, having a control system, that is in control communication with one or more local controllers associated with an EFMS. The control system has one or more operation control command plan for performing an operation plan. In embodiments, these operation plans can be, one or more of, a hydration plan, a lockout plan, a low line pressure plan, an adjacent structure based plan, and an auto-activation notice with default activation plan. In embodiments the control system executes, or carries out these various plans based upon raw data, derived data, predictive data, adaptive strategies, virtual data, and combinations and variations of this data.

Embodiments of the present inventions relate to systems, equipment and methods for the monitoring, control and management of hydration levels in the area surrounding a structure for the prevention, mitigation and management of wildfires. In preferred embodiments, the hydration levels are determined, established or maintained for predetermined areas surrounding a structure. Further, embodiments of the present inventions include predetermined hydration plans, including, plans based upon raw data, derived data, predictive data, adaptive strategies, virtual data, and combinations and variations of this data.

Embodiments of the present inventions relate to systems, equipment and methods for the monitoring, control and management of nearby EFMSs and internal fire management systems, in larger areas and smaller areas, including down to adjacent parcels, based upon raw data, derived data, predictive data, adaptive strategies, virtual data, and combinations and variations of this data. surrounding a structure for the prevention, mitigation and management of wildfires.

Embodiments of the present inventions relate to systems, equipment and methods for the monitoring, control and management of peripheral systems to EFMS and an internal fire management system, based upon raw data, derived data, predictive data, adaptive strategies, virtual data, and combinations and variations of this data.

In general, in embodiments of the present invention, the EFMS is part of, or on a network, and receive information, e.g., data, about conditions around and near the structure that EFMS is associated with and protects. This information could come from any number of sources, for example, external moisture or hydration sensors, optical sensors and devices, other EMFSs, emergency networks, user input, first responder input, and water pressure sensors. This information can be provided to the control system, and based upon the algorithms and programing of the control system the control system can shut down a particular EFMS. This embodiment would be a local controller having a lockout program for its specific EFMS.

In general, embodiments of the present systems and methods inventions relate to EFMS and networks having interlocking control systems and methods that control the operation of individual EFMS based upon events and conditions of an entire area or zone of a plurality of EFMSs.

Turning to FIGS. 1A and 1B, there is provided a general example of an embodiment of an emergency communication systems, which is an emergency management control network and system for a geographic area or location, such as a community. The communication system 1000, has a network 101. The network 101 may be any type or combination of types of communication and data networks. Thus, for example, the network 101 can be a distributed network, a direct communication network, a control network, the internet, the world wide web, a wireless network, a cellular network, a Wi-Fi network, a hard-wired network, an Ethernet network, a satellite network and combinations and variations of these, and other data and information communicate equipment and process that are presently known and may become known in the future.

The fire emergency communication system 1000 has several nodes or communication points, each node or communication point having one or more receiving device, monitoring device, transmitting device and combinations and variations of these. There is a node 110 that is associated with a residential area, e.g., a nodal area. There is a node 105 that is associated with a rural area, e.g., a nodal area. There is a node 103 that is associated with an area having access to a limited access highway, e.g., an intersection nodal area. There is a node 104 that is associated with an urban area, e.g., an urban nodal area. Each of these nodes, also has a number of individual nodes within, or associated with them. The individual nodes within a node, form a nodal area, nodes that are mobile can move from one nodal area to another nodal area.

It is understood, that one, tens, and hundreds of nodal areas, each having one, tens and hundreds of nodes, can be associated with the communication system 100, and network 101. Moreover, multiple networks, such as network 101, can be associated with, or a part of, the communication system 1000.

The number and types of nodal areas may vary, from situation to situation, community to community, from public services team/organization to public services team/organization and may vary before, during and after a wildfire.

The number and types of individual nodes, in any given nodal area, may vary, from situation to situation, community to community, from public services team/organization to public services team/organization and may vary before, during and after a wildfire.

In the embodiment of FIG. 1A, the network 101 of fire emergency communication system 1000 has as individual nodes: dwelling (house, apartment building, condo building, hotel) 112, dwelling (house, apartment building, condo building, hotel) 114, mobile device (cell phone, On-star, apple watch, etc.) 115, mobile device (cell phone, On-star, apple watch, etc.) 116, First Responder (police, Ambulance, EMS (emergency medical services), Red Cross, National Guard, etc.) 117, school 118, first responder unit 120, fixed location monitoring station, data collection and transmission device (positioned on, e.g., cell town, power line pole, etc.) 121, dwelling (e.g., ranch, etc.) 122, airport 125, first responder 133, fixed location monitoring station, data collection and transmission device (positioned, e.g., on a traffic light, associated with a traffic camera, etc.) 136, cell tower (fixed data collection and transmission device) 137, monitoring station, fixed data collection and transmission device 138, mobile device (cell phone, On-star, apple watch, etc.) 140, Emergency Management (head quarter, command center, etc.) 143, police department 144, fire department 145, Ambulance 146, Hospital 147, business (office, retail shop, restaurant, manufacturing, etc.) 150, traffic camera/red light camera (fixed data collection and transmission device) 151, and fixed data collection and transmission device (e.g., positioned on or with a cell tower 152).

Further these nodes may be viewed as sub-nodes of a larger node. For example, fire emergency communication system 101 could be included as a sub-node in a larger communication network, having one, tens, hundreds of similar fire emergency communications systems.

The individual nodes typically and preferably have GUI. They may have associated keyboards, key pads, touch screens, voice control, etc., and combinations and variations of these. The GUI have displays that among other things have graphics for providing information about traffic, fire location, evacuation, evacuation routes, location of gas stations, location of first responders, as well as, the ability to have user input of real time data, e.g., user location, presence of ambers, visibility, proximity to fire, traffic conditions. Preferably, icons, windows or screens are provided on the GUI by an application (app) that is loaded onto a mobile device, such as a smart phone, tablet or vehicle GPS/navigation system. The GUI may also be configured to provide real time, historic, derived, predictive, and virtual data. The GUI may be configured to have private access on the then network to another node on the network. For example, mobile device 140 may have a private communications path with dwelling 112, enabling mobile device to display real time raw data (e.g., images, temperature) of the conditions around dwelling 112 and send instruction to dwelling 112. For example, to activate a fire suppression system for dwelling 112. The monitoring unit of dwelling 112 may also have a processor, or be in communication (control communication) with the processing system to automatically activate the fire suppression system for dwelling 112, sent notifications to mobile device 140 recommending activation of the fire suppression system for dwelling 112, as well as, sending notice that the fire suppression system has been activated. The notices may also be broadcast over the entire network, only to the area where the node or dwelling is located, only to first responders (e.g., emergency services, fire, police, ambulance etc.) and combinations and variations of these.

The network 101, has several communication pathways. These pathways may be over the same routes, or portions of the network 101, they may share some but not all routes, they may be totally separate, and combinations and variations of these. Each route or pathway may have its own proprietary communication protocol, it may use a publicly available protocol. The protocols may include, but are not limited to CoAP, MQTT, AMQP, WAMP, LoRAWAN, LoRa, IPv4, or IPv6. The communication, e.g., the data and information set over the pathway may be encrypted, protected, or otherwise encoded, such that only an intended recipient can receive it, for example a predetermined recipient, e.g., an individual who has taken the necessary steps to rightfully receive information and data from the data processing assembly 139.

Each individual node preferably has the ability to receive and transmit data and information. However, a node only needs the ability to receive or transmit data or information. For example, in some embodiments of monitoring stations they may only transmit data and information.

Turning to the residential area 110, there is shown a schematic representation of an example of a residential area. (The residential area may be a part of, adjacent or far removed from the other areas in the system.) The residential area 110 has street 111. The various node in this area each have communication pathways: dwelling 112 has communication pathway 112a, mobile device 115 has communication pathway 115a, mobile device 116 (which is in dwelling 114) has communication pathway 116a, first responder 117 has communication pathway 117a, school 118 has communication pathway 118a. In addition, dwelling 114 has a private security system that has a communication pathway 114a to a private security provider. As discussed below, such nodes, e.g., 114, can be brought into the system 1000, by the private security provider feeding, i.e., providing or transmitting, data and information from its network or customers to the processing system 139.

Turning to the rural area 105, there is shown a schematic representation of an example of a rural area. (The rural area may be a part of, adjacent or far removed from the other areas in the system.) The rural area 110 has winding, narrow country road 107, a large area 108 (shown by dotted line) that contains significant fuel sources for a wildfire, and power lines 106. The various nodes in this area each have communication pathways: first responder unit 120 has communication pathway 120a, monitoring station 121 has communication pathway 121a, dwelling 122 has communication pathway 122a, cell tower fixed data collection and transmission device 137 has communication pathway 137a, and monitoring station 138 has communication pathway 138a. And, airport 125, which is adjacent to residential area 110 and rural area 105 has communication pathway 125a,

Turning to the limited access highway area 103, there is shown a schematic representation of an example of a limited access highway and its surroundings. (The limited access highway area may be a part of, adjacent or far removed from the other areas in the system.) The limited access highway area 103 has a multilane limited access highway 131 having multiple on and off ramps, e.g., 132, and a street 130. The various nodes in this area each have communication pathways: monitoring station 136 has communication pathway 136a, mobile device 140 has communication pathway 140a, and first responder 133 has communication pathway 133a.

Turning to the urban area 104, there is shown a schematic representation of an example of an urban area. (The urban area may be a part of, adjacent or far removed from the other areas in the system.) The urban area 104 has a street 141 that intersects street 142. The various nodes in this area each have communication pathways: traffic camera/red light camera 151 has communication pathway 151a. And a fixed data collection and transmission device (e.g., positioned on or with a cell tower 152) adjacent to the urban area 104, has communication pathway 152a. In addition, business 150 has a private security system that has a communication pathway 150a to a private security provider. As discussed below, such nodes, e.g., 150, can be brought into the system 1000, by the private security provider feeding, i.e., providing or transmitting, data and information from its network or customers to the processing system 139.

Emergency Management (head quarter, command center, etc.) 143, has communication pathway 143a, police department 144 has communication pathway 144a, fire department 145 has communication pathway 145a, ambulance service 146 has communication pathway 146a, and hospital 147 has communication pathway 147a.

The network 101 has pathway 102 that connects the network to processing system 139 (as shown in greater detail in FIG. 1B). Here one path way is shown, it being understood that multiple pathways to the processing system 139, multiple processing systems and combinations and variations of these can be used.

The network 1000 can have multiple private pathways. For example, a dwelling can have an external fire protection system that has a control system, sensors, actuators and communication pathway. This external fire protection system has a private communication pathway with processing system 139, as well as, with one or more mobile devices that also connect to processing system 139 and directly or through the processing system to the control system of the dwelling's fire protection system. There may be tens, hundreds or more of these private pathways. As the processing system 139 receives more data and information it can determine if recommendations to start a particular dwelling's fire protection system should be sent, or if the command to start the system should be sent. This can also be done on an area by area basis.

Thus, for example, the processing system 139 is receiving real time raw data from multiple nodes in the network that provide real time information about, for example traffic patterns, location of fire, speed of fire, direction of movement of the fire, wind speed and direction, humidity, number and location of persons, location of first responders. The processing system 139 also has access to historic data, such as prior weather, prior fire patterns, prior traffic patterns, surveys of fuel sources for the fire, and geographic terrain. The processing system using the real time raw data, and preferably, but not necessarily, the historic data can provide derived data about fire movement, traffic patterns, resource allocation, preferably this derived data can be predictive data. Different forms, and types of this derived data and predictive data can then be transmitted out onto the network to different nodes. For example, the information a mobile device may receive could be limited to the status of a fire suppressions system linked to that device, the proximity of the fire, the predicted path of the fire, traffic and suggested evacuation routes. The information provided to first responders and emergency management HQ could be far more extensive. For example, historic data about the number of dwellings having external fire suppression systems in a particular area, the fuel sources in that area, coupled with real time raw data about the number of people in that area, could be used to determine the placement of first responders, and the need for evacuations.

Nodes, nodal areas, individual nodes may be organized and configured into various sub-nodes. These sub-nodes can be private or semi-private or public. For example, a company could have a private sub-node for its employees, and within that a sub-node for its fleet of vehicles. Similarly, a school could have a sub-node for its children and parents. A sub-node could include all of the nodes that are external fire management systems, and then have sub-nodes for particular types of system, e.g., by provider, level of services, etc.

Turning to FIG. 1B, there is shown a schematic of an embodiment of a data processing system or assembly 139. The data processing system 139 has a network 190 that provides communication pathways to the components of the data processing system 139. The data processing system has a network 190 for transferring information and data between the various components. Incoming information, from pathways 191, 192, 193, is received by unit 194. Pathways 191, 192 and 193 are other sources of raw data, historic data and even predictive and derived data. Processor 195, which may be a computer, has the algorithms and programs to provide the derived data and predictive information, as well as, provide adaptive responsive strategies. Processor 195 also preferably controls the network traffic with and between storage devices 196, 197, 198 and unit 199. Unit 199 is for sending and receiving information to and from the network 101. It should be understood that system 139 may itself be distributed over a network, or reside on the cloud. Unit 194 and 199 may be the same unit, or they may be multiple separate or distributed units, and combinations and variations of these.

Unit 199 receives and provides information, data and control communication to and from the data processing system 190 to the network 101. Data to individuals is sent along pathways 180 for standard data and content, and along path 181 for premium data and content. For example, standard data may show only public service announcements and other official information from the authorities. Premium data, can show predicted fire movement, number and location of external fire management systems (and their status over time).

Both of these individual data streams, sets or packets, e.g., data for individuals, travels along pathway 102 of network 101. This data for individuals travels along pathway 102 to a smart phone, tablet, such as an iPad®, a GUI in an automobile (dash display), or other GUI, where one or more of raw data, derived data, adaptive strategy information and predictive data are presented on the display. Thus, for example, data may travel along pathway 181 to pathway 102 to one or more individual pathways (e.g., 113a) or to a nodal area, e.g., 110, or the entire network. The data is then displayed on the GUI associated with the node (e.g., 113) and information may be input into the GUI and then transmitted along the individual pathway to the network pathway 102, to a pathway, e.g., 181.

The other pathways from unit 199, e.g., pathway 182, 184, 186, etc., are for other custom or special communication or sub-networks. Thus, by way of example, pathway 182 can be for controlled communication for external fire management systems. Realtime raw data, derived data, adaptive strategy information and predictive data may be sent to a user's mobile node, a fixed node on the external fire management system and both. The user can then monitor the information and elect to send a command to the external fire management system to, for example, become read, to operate, or to operate upon a certain set of conditions. The system 139 can send predictive data, e.g., recommending that the external fire management system is activated. The system 139 can also send information, data, or a command to one or more external fire management systems that cause the system(s) to operate.

In this manner the system 139 can provide derived data and adaptive strategies, to individuals and entire areas, in a direct response to changing fire conditions. This provides the ability to save fire suppression resources (i.e., water, foam) until they are absolutely needed, to use them in the most efficient manner, both on a micro level (each individual system, or structure) and on a macho level, (most efficient use of systems, and activation/operation strategy to protect an area).

By way of example, pathway 184 can be non-public and exclusive to fire response teams. Pathway 185 can be non-pubic and exclusive to all first responders. Pathway 183 is for communication with network television and social media. This pathway allows specified data and information from the system 139 to be broadcast to a GUI 186, e.g., a TV or computer monitor, on public networks and social medial.

Generally, the sources for incoming raw data for use in, or to form a basis for, the algorithms and mathematical computations that a processor performs to provide derived data and predictive information and adaptive strategies, can come from various sources, including for example: individual mobile devices (e.g., input from persons, first responders, emergency services, satellites), fixed monitoring devices (e.g., cell tower mounted devices, external fire suppression system, fire services, weather services, traffic monitors, first responders, emergency services, etc.).

Because of the complexity and unpredictability of wild fires, fire emergency and the reactions of persons, although a single approach may be used, in an embodiment a multi-approach system approach is used, the multi-approach having two, three, four or more approaches performed at the same time to determine a set of approach values for a given event at a given point in the fire emergency. These approach values, e.g., probability of event occurring, are then given weightings based upon their individual accuracy for a particular point in the fire emergency, e.g., rural fire, fire size, population levels, population density in relation to ingress and egress routes, start (activation) of an external fire management system, number of EFMSs in a location, etc. The weighted approach values are then combined to provide a predicted value, i.e, derived data of a predictive nature, such as for example an adaptive strategy, a recommendation to activate a particular EFMS, a warning to evacuate, etc.

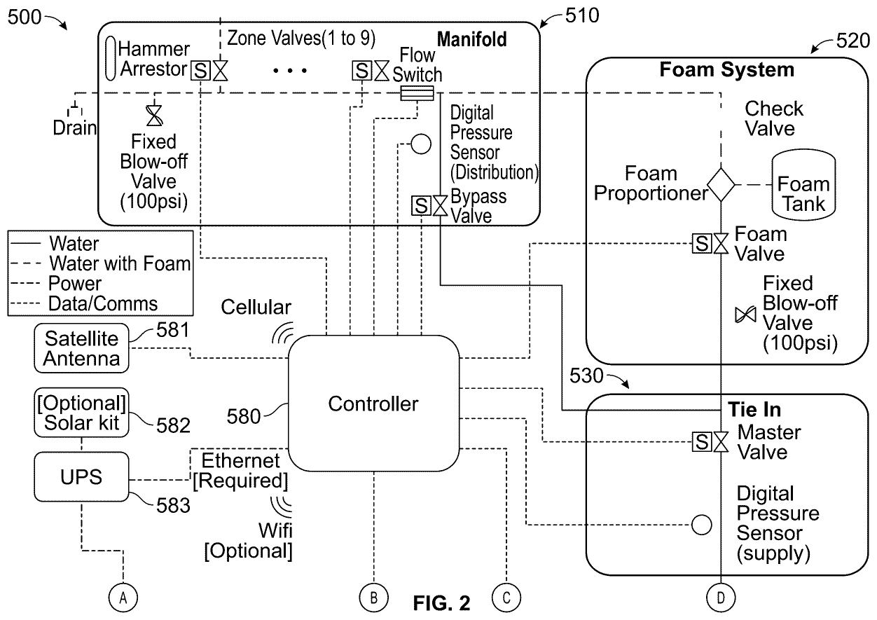

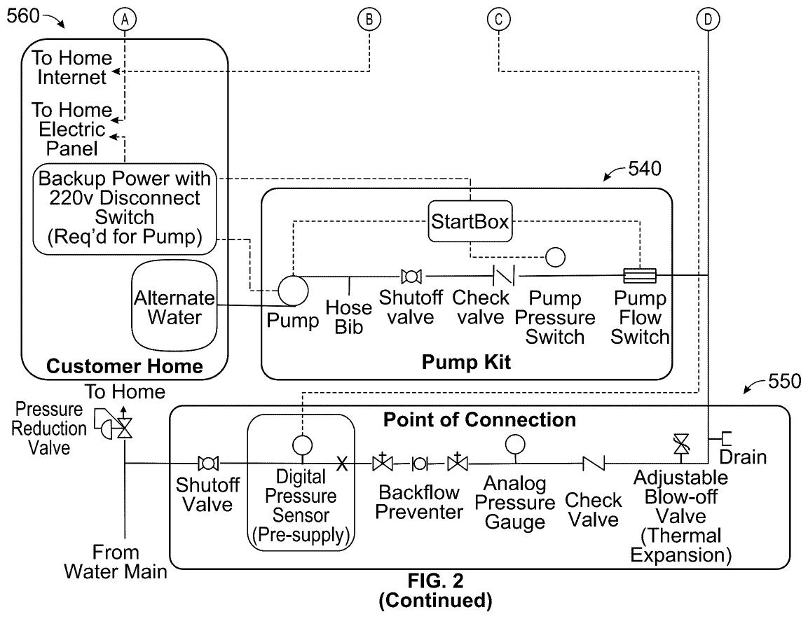

Turning to FIG. 2 there is shown a schematic of a general embodiment of an EFMS 500. The controller 580 is connected to the network of a fire emergency communications system by one of two or both path ways, i.e., cellular and WiFi to home internet. One, two, ten or more structures in an area can have these EFMS 500. The network can have EFMS of other configurations as well, such as the types generally provided in this Specification. The EFMS can include a manifold 510, a foam system 520, a tie in 530, a pump kit 540, a point of connection 550, a satellite antenna 581, an solar kit 482, and a UPS (universal power supply). These components are associated with a structure (e.g., a house) 560. The system can also have a GUI that is wall mounted or otherwise located at the structure, the GUI is in control communication with the controller 580 and also can be in control communication with a remote GUI, as well as other nodes on a network.

The controller 580 can be in control communication with an operation control command plan (e.g., a determined, including a predetermined, course of action based upon certain inputs, data or both). These control commands can reside entirely in the controller 590 (e.g., the memory associated with the controller and be executed by the processor in the controller), they can reside in a control system in the cloud and be executed by a cloud-based processor, they can be distributed between the cloud and the controller 580, i.e., between the cloud-based control system and the local controller.

In general, the EMFS 500 can be a node on a fire emergency communication system, like system 1000, and these fire emergency communication systems can have 5, 10, tens, hundreds, thousands of EFMS as nodes on the system.

The control commands, including the operation control command plans, can be updated, deleted, replaced and managed, for example, via the cloud, via the network, locally and combinations and variations of these.

In general, a control system sends control commands to activate and operate the EMFS, sends commands to a local controller 580 to activate and operate the EMFS and combinations and variations of these depending upon the network and controller configuration. These control commands, among other things, start and stop the operation of the EMFS, thus these commands determine, among other things, the number of cycles, time between cycles, duration of a cycle, as the operation control command plan is carried out through the operation of the EFMS. The stop commands, e.g., deactivate and stop operation of the EFMS, lockout the EFMS, can be based upon a timer, monitored hydration levels, communications from a control system, a GUI, or another notice on the network, as well as, other factors.

Internal fire suppression systems, such as the type having interior sprinkler heads that are activated upon the detection of condition indicating a fire, e.g., increased heat, smoke, can be a node on the network, they can be in communication with an EMFS, either directly (e.g., local controller to local controller), through a GUI, through a control system (e.g., cloud or network controller), and combinations and variations of these, as well as, other control communications configurations. The internal fire suppression systems, would directly protect interior walls, and floors, as well as, furniture, appliances and occupants (such as to facilitate evacuation from the effective structure or room, or to assist in fighting the interior fire).

Generally, the EFMS is in control communication with a control system that has control commands. These control commands can be as simple as an activation signal, a valve open or shut signal, and include more complex or detailed control commands. These more detailed control commands include an operation control command plan for performing an operation plan, such as a hydration plan, a lockout plan, a low line pressure plan, an auto-activation notice with default activation plan, an adjacent structure based plan, etc. These control commands can reside: entirely in local controllers (e.g., data storage and memory associated with a controller at an EFMS of a structure and be executed by the processor in that controller); they can reside in the cloud (e.g., storage and memory associated with a cloud-based controller and be executed by a cloud-based processor); they can reside on the GUI, or, they can be distributed between the cloud, the GUI, the local controllers and combinations and variations of these configurations. In general, the control commands, e.g., the operation control command plans, are programs having, or based upon, algorithms, for executing the operation of the systems, including particular operation plans. The operation control command plan provides for the system to operate and implement an operation plan. The operation plan can be any of the types of plans, disclosed or suggested in is specification, such as a hydration plan, a lockout plan, a low line pressure plan, an auto-activation notice with default activation plan, and an adjacent structure based plan. The operation control command plan can be any multi-operation or multi-step plan for operating the EFMS, the internal fire suppression system and both. The operation control command plan can be based upon data, information and user input, such as, hydration levels, cycle times, wetting rates, fire risk, wind speed and direction, adjacent systems status, other systems status, an activation command, water line pressure, etc.

In embodiments the control system is configured to interface, and thus be in control communication, with the control system for an irrigation system. These irrigation systems can be any system for providing water to agriculture, e.g., lawn, plants, trees, vegetation near or around a structure or in a particular area. Typically, these irrigation systems have a network of pipes or tubing that is connected to a series of sprinklers, or other water distribution devices. Typically, these irrigation systems have a controller that is capable of being a node on a network, or otherwise capable of being in control communication with other devices, such as embodiments of the present control system, e.g., a cloud based control system. If, however, the controller for the irrigation system does not have communication capabilities, it can be modified to provide such capabilities. Such modification includes the addition of a cellular, WiFI or hard wire (e.g., ethernet) communication device. In general, the irrigation system will already be installed at a structure (e.g., a preexisting irrigation system), prior to the installation of the EFMS. However, it is to be understood, that both systems could be installed at the same time (e.g., with new construction) or the EFMS may be installed first with the irrigation system being added later. Thus, in an embodiment the local controller from the EFMS, the control system for the EFMS, or both, are in control communication with the irrigation system. In this manner the water supply, the tubing and the sprinklers of the irrigation system can be specifically used for wildfire mitigation and management. In particular, in an embodiment, the water supply, the tubing and the sprinklers of the irrigation system, can be used, controlled by the operation control command plan for performing an operation plan, of the EFMS, to perform the operation plan.

In an embodiment of the present control system, the control system is configured to have the ability to be control communication with different types of local controllers. These local controllers can be for an EFMS, an irrigation system, an internal sprinkler system, an HVAC system, a security system, a lighting system or other systems. In addition to being configured for communication with these different types of local controllers, the control system is configured for communication with different types of communication protocols, e.g., as used by different manufactures, for each of these different types of systems. Thus, the control system can be configured to be capable of control communication with one, two, three, four, five or more different types of systems. Further, for each of these different types of systems, the control system can be configured to be in control communication with one, two, three or more different communication protocols. In an embodiment, the control system has one or menus, e.g., a series of menus, that are presented on a GUI to guide a user to select predetermined configurations to establish such control communications, and in this manner connect the local controller to the control system.

The operation control command plan can be “predetermined”, in which case the operation plan, and the steps or processes for that plan are fixed, and cannot be changed by the control systems itself. Recognizing of course, that such predetermined operation control commands can be updated, upgraded or otherwise managed, by manufactures, systems providers, systems managers, users (although not preferably) and the like. The operation control command plan can be “determined”, in which case the operation plan, has steps or processes that are established, however, the frequency, timing, magnitude (e.g., amount of flow), duration, sequence, etc., can be changed by the control system (as well as the local controller or both) upon receipt of data or information, preferably real time data and information about environmental conditions (e.g., hydration levels, cycle times, wetting rates, fire risk, wind speed and direction, adjacent systems status, other systems status, water line pressure, etc.). In an embodiment, the determined operation control command plan could be an adaptative strategy control command.

The control system sends control commands to activate and operate the EMFS, sends commands to a local controller to activate and operate the EMFS and combinations and variations of these depending upon the network and controller configuration. The control system, in some embodiments, can also send control commands to activate and operate internal fire suppression system, sends commands to a local controller to activate and operate the internal fire suppression system and combinations and variations of these depending upon the network and controller configuration. The control commands, among other things, start and stop the operation of the EMFS, thus these commands determine, among other things, the number of cycles, time between cycles, duration of a cycle, as the hydration plan is carried out through the operation of the EFMS. The stop commands (e.g., deactivate and stop operation of the EFMS, and lockout the EFMS), can be based upon a timer, monitored hydration levels, the status of hydration levels of areas and locations, the status of fire suppression systems, internal to a structure and external to the structure, (e.g., armed, operating, standby, available water pressure, etc.) and the water pressure or line pressure of areas and locations., as well as, other factors.

In general, embodiments of the EMFS can be made up, in whole or in part, of irrigation system components; and in particular, one or more of: the water line into the irrigation system, the manifolds or distribution headers for the irrigation system, the tubing or piping connecting the irrigation system to the water distribution devices, e.g., sprinkler heads, the local controller for the irrigation system, and the water distribution devices, e.g., sprinkler heads, for the irrigation system.

In a general, embodiments of an EMFS can have hydration plan control commands, for carry out the hydration plan, the EMFS can have and can receive input from devices that directly or indirectly monitor the hydration levels of combustible materials in predetermined areas, i.e., zones, that surround the structure. The devices for monitoring the hydration levels of combustible materials, can include for example: soil moisture sensors; moisture sensors on, or in, vegetation; visual sensors (e.g., color of vegetation); humidity sensors; temperature sensors; data input, memory and processors that can predilect or determine hydration levels and hydration trends, and combinations and variations of these and other devices. The zones are primarily configured based upon a predetermined distance from the structure. The zones may also be configured based upon natural fire breaks, fire risk and other geographic or environmental factors.

Thus, there is typically a first, or inner zone, which is adjacent to the structure and extends out from the structure a few feet to yards (meters). There is typically a second zone, which is adjacent to the first zone (or which can be overlapping) and extends outwardly from the first zone further away from the structure by a few feet to a few yards (meters). In the two-zone embodiment, the second zone would be the outer zone. There can also be a third zone, in which case, the second zone would be considered the middle zone, and the third zone would be considered the outer zone. The third zone would be adjacent to the second zone (overlapping or not over overlapping) and extends outwardly from the second zone further away from the structure by a few feet to a few yards (meters). Additional, zones extending further away from the structure may also be used.

Generally, the hydration plan, and hydration plan control commands, can have predetermined, derived or both, hydration levels for each zone, and then operate the EFMS to maintain those hydration levels. The hydration levels for each zone can be the same or different. The hydration levels can be varied based upon for example: season, weather conditions, and wildfire information and data. Thus, for example, the hydration levels for each zone can be: (i) predetermined, e.g., a higher level of hydration during fire season, e.g., higher hydration level in inner zone, or both zones; (ii) they can be determined by the control system based upon incoming data, e.g., active fire near structure, which would increase hydration levels in both inner and outer zones, or inner zone first, then outer zone, if/as fire approached; (iii) user input, e.g., setting a desired hydration level, e.g., higher, hydration level for one or more zones; (iv) local zoning, water use requirements, including water use requirements during an active fire event; (iv) based upon derived data, e.g., fire risk conditions calculated based upon real time raw data; and (v) combinations and variations of these, as well as other factors.

In general embodiments of these EMFS having a hydration plan and the hydration plan method, e.g., the hydrating of the surrounding combustible materials in the areas or zones surrounding the structure, can be configured to remotely protect structures during a wildfire. The system has a source of data that identifies or defines an area around a structure and provides the hydration level of combustibles around that structure and in the area.

The area can be a series of areas, with each area having a periphery that extends out further from the structure. In this manner the amount of hydration of the combustible material in each of these areas is provided.

These areas could be concentric, e.g., concentric circles, squares, ovoids or rectangles. These areas can be based upon the shape, e.g., foot print, of the structure, and thus extend outwardly from that foot print by a set distance, and thus the shape of the area would be a larger but similar shape foot print to the structure. These areas can be any geometric shape with one being located inside the other and having a common center point, or different center points. These areas could be overlapping, and partially overlapping (e.g., along the lines of Venn diagrams). These areas could follow the exact shape of the foot print of the structures, thus being a set distance from each wall. The areas can take into account multiple structures, e.g., garage, shed or coach house. These areas may also be based upon, or shaped, to take into consideration the natural contours of the land around the structure, fire breaks such a highway or rivers, and likely wind patterns, among other natural factors, to further define the shape and size of the areas. These areas can use one or more, and combinations and variations of the foregoing shapes and arrangements.

The areas can also be determined based primarily upon the amount of hydration of the combustibles around the structure. Thus, in periods when the combustibles are very dry, i.e., low levels of hydration (less than 50% water content, less than 25% water content, less than 10% water content, and less than 5% water content) the area can be expanded to provide a large area around the structure for mitigation and monitoring purposed.

The areas can be hydrated based upon specific amounts of water being applied to the area or zone. Thus, Home Ignition Zone 0 (HIZ0), which is adjacent to the structure, i.e., the inner zone or area, can have a primary hydration amount of: about 2″ of water per 24 hour period; about from 1″ to about 2″ of water per 24 hour period; about 0.7″ to 1.2″ of water per 24 hour period; and, preferably for an HIZ0 having distance from the structure of 5 feet, 1″ of water per 24 hour period.

The next zone away from HIZ0, and adjacent to HIZ0, which is HIZ1, (outer zone for two zone embodiment, middle zone for three zone embodiment) can be hydrated based upon specific amounts of water being applied to the area or zone. Thus, Home Ignition Zone 1 (HIZ1), which is adjacent to HIZ0 can have a primary hydration amount of: about 1″ of water per 24 hour period; about from 0.5″ to about 1.2″ of water per 24 hour period; about 0.3″ to 0.8″ of water per 24 hour period; about 0.1″ to 0.3″ of water per 24 hour period; and preferably for an HIZ1 having distance from the structure that is adjacent to HIZ0 (e.g., 5 feet from the structure) and extends out to 30 feet from the structure, 0.25″ of water per 24 hour period.

After the primary hydration amount is applied, it is preferable that a replenish amount of water is applied to the area or zone, and that this is applied daily during dry conditions, red flag warnings, high fire risk conditions, and combinations and variations of other factors.

Thus, for HIZ0, for each 24 hour period following the primary hydration, a replenishment hydration amount of: about 1″ of water per 24 hour period; about from 0.3″ to about 0.8″ of water per 24 hour period; about 0.4″ to 0.9″ of water per 24 hour period; and preferably for an HIZ0 having distance from the structure of 5 feet, 0.5″ of water per 24 hour period. These others factors can be received, determined or both from data and information provided to the control system for the EFMS having a hydration plan.

Thus, Home Ignition Zone 1 (HIZ1), which is adjacent to HIZ0 can have a replenishment hydration amount of: about 0.4″ of water per 24 hour period; about from 0.1″ to about 0.4″ of water per 24 hour period; about 0.10″ to 0.25″ of water per 24 hour period; and preferably for an HIZ1 having distance from the structure that is adjacent to HIZ0 (e.g., 5 feet from the structure) and extends out to 30 feet from the structure, 0.13″ of water per 24 hour period.

The level of hydration that is maintained in the various zones, e.g., HIZ0, HIZ1, HIZ2, etc. can be measured by Fuel Moisture Content (“FMC”). Fuel moisture content is the percentage of a given fuel's weight, represented by water, based on the dry weight of the fuel. Thus, it is: Percent Moisture Content=Weight of Water/Oven-dry Weight of Fuel×100. It is noted that moisture content can be greater than 100 percent because the water in a fuel particle may weigh considerably more than the dry fuel itself. For example, a green leaf may contain three times as much water as there is dry material, leading to a moisture content of 300 percent. Moisture content of duff and organic soil can be over 100 percent. In embodiments the EFMS establishes and maintains a FMC in HIZ0 from about 100% to about 400%, from about 200% to about 300%, about 100% or more, about 200% or more and about 300% or more. The EFMS establishes and maintains an FMC in HIZ1 from about 100% to 300%, from about 70% to about 150%, about 75% or more, about 100% or more, and about 150% or more. The EFMS establishes and maintains an FMC in HIZ2 from about 25% to 100%, from about 30% to about 50%, about 50% or more, about 60% or more, and about 100% or more. Combination and variations of these established and maintained FMCs may be utilized, as well as, higher and lower amounts.

Further, the hydration plan, and the hydration plan control commands, can be configured to keep combustibles wet enough so that an ember attach will not ignite them. For example, the ignition point for dry grass and leaves is about 13.6 MJ/m², the ignition point for dry cushions and dry fabric (e.g., yard furniture) is about 7.5 to 19.7 MJ/m², and the ignition point for dry pine wood is about 18.1 MJ/m². The energy from a typical ember attack is about 52.2 MJ/m². In general, a preferred hydration plan will keep these materials saturated. The plan will account for hydration time (e.g., about 20 hours for wood to become saturated) amount of water needed for saturation, and evaporation. For example, about 43 gallons/100 sq ft (e.g., 62 inches of water) can be used to keep these materials saturated, under certain conditions. However, it is preferred to have a safety factor and thus use 62 gal/100 sq ft (e.g., 1 inch of water) By saturating these materials, as well as, other materials, their ignition point is raised, i.e., it takes more energy for them to ignite. It requires about 65.9 MJ/m² to heat and evaporate 1 inch of water. Thus, when these materials are saturated their ignition points are above the energy from an ember attack, and thus the amber attack will not ignite them. For example, saturated pine wood has an ignition point of 62.6 MJ/m², which is well above the 52.2 MJ/m² from a typical amber attack Moreover, if the area surrounding the structure is saturated, any spot fires that may occur should be self-extinguishing.

The control system can receive information about evaporation, calculate evaporation rates based upon data, used historic data, use real time data, and combinations and various of these to determine the amount of water needed in the hydration plan to compensate for evaporation. In extreme conditions materials can lose 0.5 inches of water per day. Typical California summers see water loose from evaporation of about 0.25 inches per day. Thus, the hydration plan can be based upon, e.g., designed to compensate for, these typical evaporation rates, preferably with a safety factor added in, e.g., 50%.

Embodiments of the hydration plans can limit the flow rate to about 24 gpm. Generally, the hydration plan will provide for periods on operation, e.g., cycles, and then periods on no operation. In embodiments hydration maintenance cycles can use about 2.5 gpm, and initial hydration cycles can use about 5 gpm.

In an embodiment the primary (e.g., initial) and replenish (e.g., maintenance) amounts of hydration for HIZ0 and HIZ1 are such that there is no need to apply water to HIZ2.

The data and information about the amount of hydration in the combustibles surround the structure can come from any available source. Moisture sensors can be located around the structure. The moisture sensors and hydration system can be of the type used for agriculture to monitor crops. It can contain moisture sensors located in the ground, or at or near the ground to determine moisture levels, and hydration levels of combustibles.

The data and information about the amount of hydration in the combustibles can also come from historic data. In this manner hydration levels based upon prior weather conditions can be analyzed and used to predict, and provide a derived hydration levels based upon current conditions. Optical sensors may also be employed to determine hydration level based upon color or visual condition of the combustibles.

The data and information about the amount of hydration in the combustibles can also come from publicly available sources, such as the depart of agriculture, local fire management systems, and weather and climate services.

The data and information about the amount of hydration in the combustibles can come from adjacent structures and other monitoring systems.

The data and information about the amount of hydration, from one, more than one, and all of these as well as other sources, is used by the EMFS for several purposes. The EMFS system, using the hydration plan control commands, can determined the amount of water needed to increase the hydration level in one or more of the areas around the house to an acceptable level. The EMFS can evaluate, one or more of, the amount of available water, predicted weather patterns, fire hazard level and other factors, to determine and implement a hydration plan, e.g., amount, time, duration, and location, of sprinkler usage to obtain an optimum hydration level based upon one or more and all of these factors.

The evaluation of the hydration data and information, and the formulation of hydration plans can be done by the EMFS systems at a local control and processing system, it can be done by a remote control and processing system, it can be done by a distributed control and processing systems and combinations and variations of these.

The hydration data and information can also be used by the EMFS system to determine the amount, duration and time of the application of fire suppressions materials, e.g., water, foam, when a fire is detected. In this manner, the minimal amount of fire suppression material can be used that are necessary, based upon hydration data and information, to suppress the fire and protect the structure.

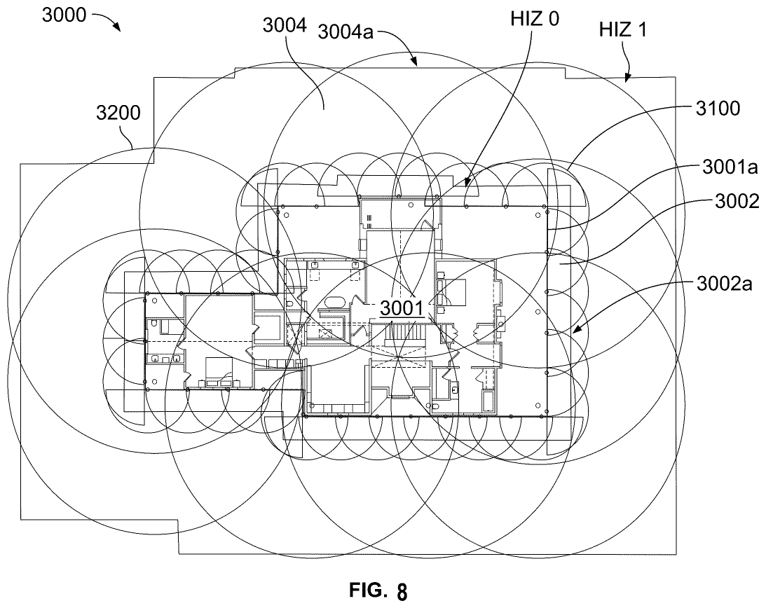

In an embodiment, enhancements in speed can be achieved by inter controller communication on the network. For example, one controller can let another controller know that it has activated, and if a second controller lets other controllers know it has been activated, then there is logic that can be applied to activate the controller receiving the activate information. The communication path for communicating between controllers does not need to be via the cloud, but rather through radio communication, such as a LoRa type system, including LoRaWAN®. FIG. 8 provides a schematic of an example of an architecture for LoRa type system. In an embodiment this architecture is deployed in a star-of-stars topology in which gateways relay messages between end-devices and a central network server. The gateways are connected to the network server via standard IP connections and act as a transparent bridge, simply converting RF packets to IP packets and vice versa. The wireless communication takes advantage of the Long Range characteristics of the LoRaO physical layer, allowing a single-hop link between the end-device and one or many gateways. All modes are capable of bi-directional communication, and there is support for multicast addressing groups to make efficient use of spectrum during tasks such as Firmware Over-The-Air (FOTA) upgrades or other mass distribution messages.

An emergency management control network and system, e.g., the embodiment of FIG. 1, can have one, two, five, tens, hundreds and more EFMS that are on the emergency management control network and system. The network can have EFMS of the types generally show in this Specification, as well as other configurations. The data processing assembly (e.g., 139), based upon raw data received from various nodes on the network, processes that raw data to provide predictive information about the location and movement of a wildfire. The predictive information is communicated over the network. The predictive information can be a control command to a particular EFMS system, such as to arm, to operate, and to stop operations. This control command information can be sent to a group of EFMS in a nodal area, e.g., a predetermined nodal area.

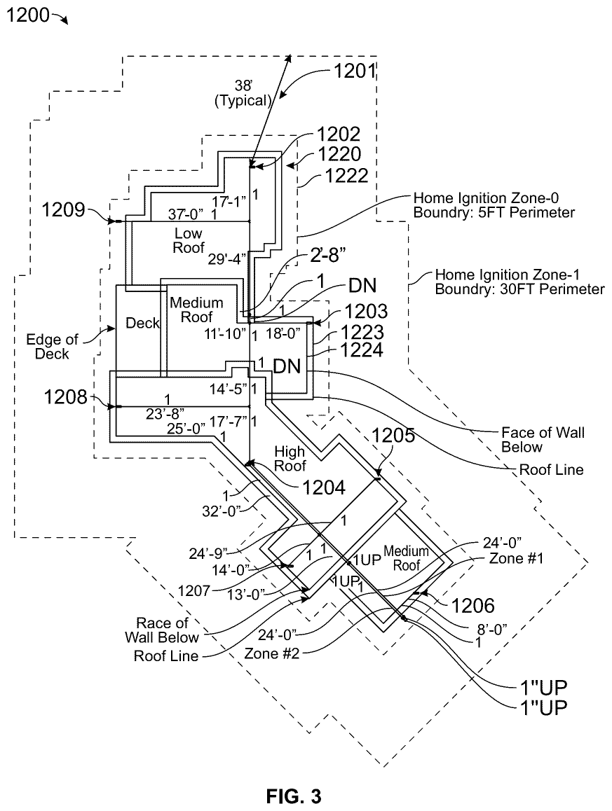

Turning to FIG. 3 there is shown a schematic of a general embodiment of an EFMS 1200. One, two, five, tens, hundreds and more can be part of an emergency management control network and system and can be a part of a coordinated wildfire management system for the protection of a community of structures. The network can have EFMS of other configurations as well, such as the types generally provided in this Specification. The data processing assembly based upon raw data received from various nodes on the network processes the raw data to provide predictive information about the location and movement of a wildfire. The predictive information is communicated over the network. The predictive information can be a control command to a particular EFMS system, to arm, to operate, and to stop operations. This control command information can be sent to a group of EFMS in a nodal area.

System 1200 provides an outer coverage zone 1201 that has an outer boundary 1221. The outer boundary 1221 is 30 ft from the walls 1224 of the house. The system 1200 provides an inner coverage zone 1220, that has an inner boundary 1222. Boundary 1222 is 5 ft from the walls 1224. The system 1200 has distribution heads 1202, 1203, 1204, 1205, 1206, 1207, 1208, 1209. When the system is activated, these distribution heads provide foam, water and combinations of foam and water to zone, 1220, zone 1201, and combinations and variations of these zones. The system is installed in a house that has an outer roof line 1203, that extend outwardly from the outer walls 1224, and thereby defines an eave. The zones 1201 and 1220 can be further subdivided into sub-zones. In this manner the system can be operated to provide water, foam, etc. to various sub-zones and combinations of sub-zones.

In an embodiment the inner boundary 1222 can be about 4 feet or about 3 feet from the walls 1224, as well as, more than 5 ft, about 6 ft, and less than 8 ft from the walls 1224. In an embodiment the outer boundary can be about 25 feet or about 20 feet from the walls 1224, as well as, more than 30 ft, about 35 ft, and less than 50 ft from the walls 1224.

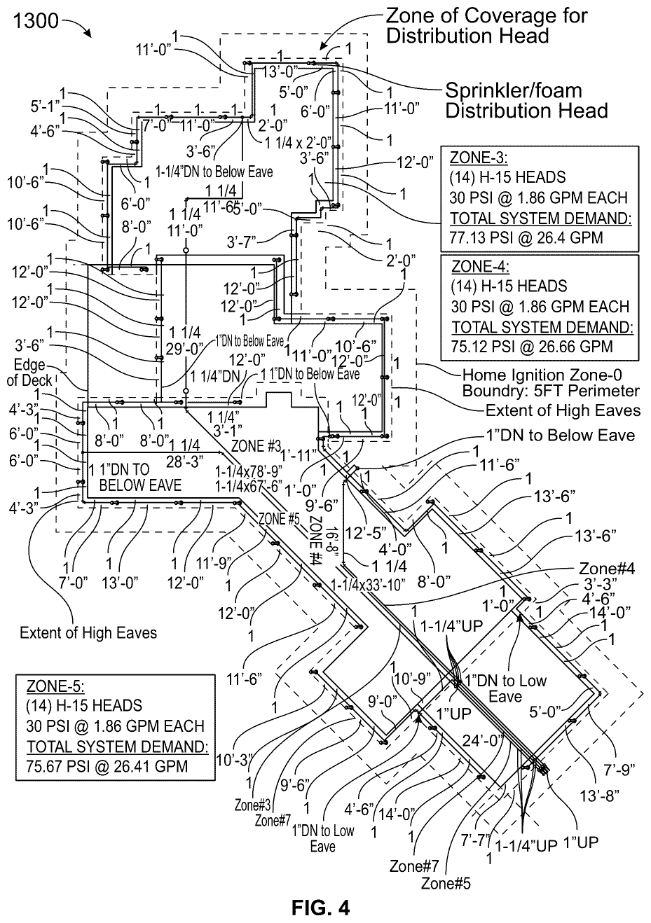

Turning to FIG. 4 there is shown a schematic of a general embodiment of an EFMS 1300. One, two, five, tens, hundreds and more can be part of an emergency management control network and system and can be a part of a coordinated wildfire management system for the protection of a community of structures. The network can have EFMS of other configurations as well, such as the types generally provided in this Specification. System 1300 provides a coverage zone that has an outer boundary. The boundary is 5 ft from the walls of the house. The system 1300 has plurality of distribution heads. When the system is activated, these distribution heads provide foam, water and combinations of foam and water to the coverage zone and combinations and variations of these zones. The system is installed in a house that has an outer roof line, that extends outwardly from the outer walls, and thereby defines an eave. The zone can be further subdivided into sub-zones. In this manner the system can be operated to provide water, foam, etc. to various sub-zones and combinations of sub-zones.

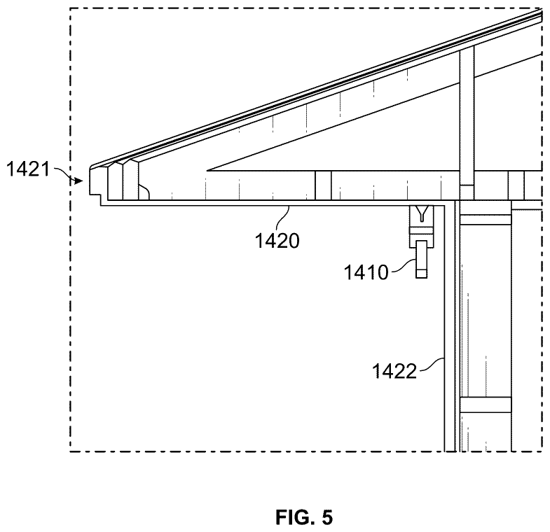

Turning to FIG. 5 there is a cross sectional schematic of a general embodiment of a distribution head 1410 installed under an eave 1420. There is also shown the outer roof line 1421, and a portion of the outer wall 1422. The embodiment of FIG. 5 can be used with any EFMS, including the various embodiments of EFMS of the present Specification

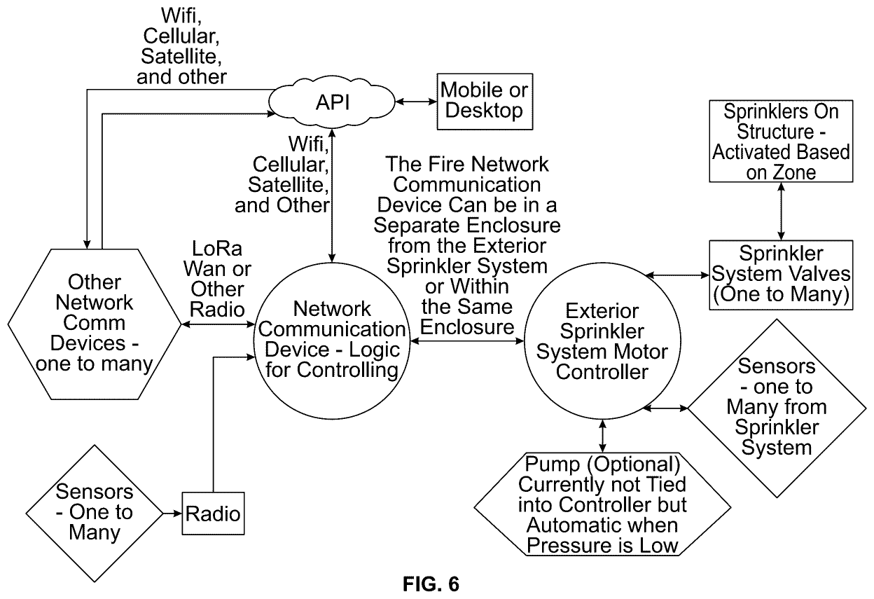

Turing to FIG. 6 there is shown a schematic flow diagram of a general embodiment of an EFMS, such as the types generally provided in this Specification. In this system there are two controllers. This system can be a part of a coordinated wildfire management system for the protection of a community of structures. A first controller (e.g., motor controller) having I/O connected to pumps valves and other sensors and device for the operation of the sprinklers and water, foam and both distributions. This first controller has a control program or control logic that controls the operation of the mechanical devices and sensors. The first control is in control communication with a second controller (e.g., Network Communication Device). This controller has a control program or control logic that can be an operating system. The second controller is configured for network communication to the cloud, peer to peer communication to other controllers in other EFMS, to make determinations based on fire, humidity, etc. sensors or other sources of data, and to provide instructions to the first controller. Thus, for example, the second controller based upon received information can make a determination to send an activation instruction to the first controller.

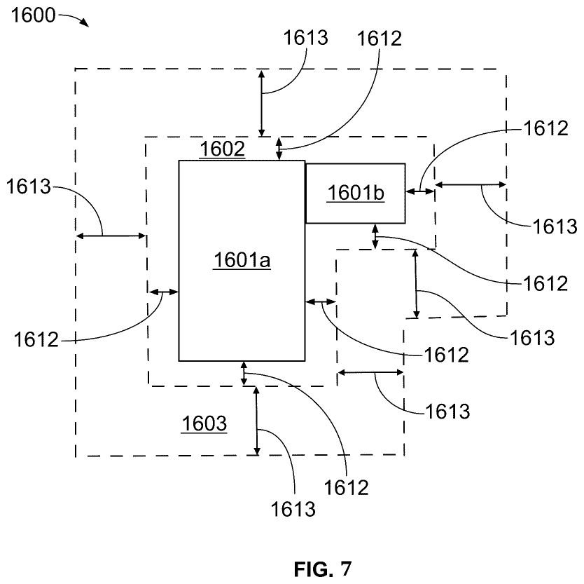

Turing to FIG. 7 there is shown a schematic flow diagram of a general embodiment of an EFMS 1600, such as the types generally provided in this Specification. This system can be a part of a coordinated wildfire management system for the protection of a community of structures. In this system there are two controllers. A first controller (e.g., motor controller) having I/O connected to pumps valves and other sensors and device for the operation of the sprinklers and water, foam and both distributions. This first controller has a control program or control logic that controls the operation of the mechanical devices and sensors. The first control is in control communication with a second controller (e.g., Network Communication Device). This controller has a control program or control logic that can be an operating system. The second controller is configured for network communication to the cloud, peer to peer communication to other controllers in other EFMS, to make determinations based on fire, humidity, etc. sensors or other sources of data, and to provide instructions to the first controller. Thus, for example, the second controller based upon received information can make a determination to send an activation instruction to the first controller.

The embodiments of the operation of EMFS systems as shown in the schematic flow diagrams of FIGS. 6 and 7, as well as combinations and variations of these can be implemented by any EFMS, including the various embodiments of EFMS of the present Specification. These embodiments of the operation of EMFS systems can have an operation control command plan for performing an operation plan. The operation plan, for example, can be one or more of a hydration plan, a lockout plan, a low line pressure plan, an auto-activation notice with default activation plan, and an adjacent structure based plan.

In an embodiment the zones around the structure exactly follow the shape of the structure, including having sharp corners. Thus, the shape, e.g., the foot print, of the zones follow and enlarge, and preferably exactly follow and enlarge, the foot print of the structure. The system having an operation control command plan is associated with a structure, having an ancillary structure (e.g., patio, outdoor kitchen, garage) to be protected from wild fire. The structures, have an EFMS. The EMFS system and its operation control command plan a first area (HIZ0) 1602 (Home Ignition Zone (“HIZ”) 0 (zero). The distance 1612 for the permitter of HIZ0 1602 from the outer walls of the structures 1601a, 1601b, can be from about 1 to 20 feet, 10 feet or less, 5 feet or less, and preferably the distance 1612 is about 5 feet. It being understood that HIZ0 is adjacent to, and can include the outer surface of, the outer wall of the structures 1601, 1601b.

The EMFS system and its operation control command plan establishes a second area (HIZ1). The distance for the permitter of HIZ1 from the end of H1Z, can be from about 5 to 50 feet, 40 feet or less, 30 feet or less, and preferably the distance is about 25 feet. It being understood that HIZ1 is adjacent to HIZ0 (slight overlap with HIZ0 can occur). Thus, the distance for the permitter from HIZ1 from the structure outer walls is typically the sum of these distances.

Embodiments of this EMFS have an operation control command plan for performing an operation plan. The operation plan, for example, can be one or more of a hydration plan, a lockout plan, a low line pressure plan, an auto-activation notice with default activation plan, and an adjacent structure based plan. Thus, for example, the EMFS is in control communication with the operation control command plan, which can be part of a control system, on the cloud, a local controller and combinations and variations of these, as well as the other configurations discussed in this Specification.

Turning to FIG. 8 there is shown a schematic of a general embodiment of an EFMS 3000 having an operation control command plan. The system 3000 has an EFMS that is associated with structure 3001. This system can be a part of a coordinated wildfire management system for the protection of a community of structures. The EFMS has a series of sprinkler heads on or near the structure that provide sprinkler patterns, e.g., area where the sprinkler head delivers water, fire suppressant, or combinations of these. The sprinkler patterns are overlapping, with the smaller patterns, e.g., 3100 being overlapped by the larger patterns, e.g., 3200. The EFMS establish two zones HIZ0, 3002 and HIZ1, 3004. HIZ0 is adjacent to the outer wall 3001a of the structure 3001. HIZ0 has a footprint 3002a. HIZ1 is adjacent to HIZ0 and extends outwardly from HIZ0 away from the structure 3001 and has footprint 3004a. As can be seen in the figure, the footprints 3002a and 3004a have a larger but otherwise identical shape to the shape of structure 3001, and in particular the outer walls 3001a. It can also be seen that the smaller sprinkler patterns, e.g., 3100, completely cover HIZ0 (i.e., 100% of the area of HIZ0 is covered by the patterns, e.g., 3100) and that the larger patterns, e.g., 3200, overlap the smaller patterns, and cover substantially all of HIZ0, as well as HIZ1. The lager patterns can be configured to cover all of the area of HIZ0, as well as all of the area of HIZ1.

In embodiments, the larger sprinkler patterns cover at least 95%, at least 98%, at least 99% and 100% of the area of HIZ0. In embodiments, the smaller pattern covers at least 98% of the area of HIZ0, at least 99% of the area of HIZ0 and 100% of the area of HIZ0. In embodiments, the larger sprinkler patterns cover at least 95%, at least 98%, at least 99% and 100% of the area of HIZ1. Combinations and variations of these coverages can implement, and can be implemented based upon the exposure of the property, e.g., risk.

Embodiments of this EMFS have an operation control command plan for performing an operation plan. The operation plan, for example, can be one or more of a hydration plan, a lockout plan, a low line pressure plan, an auto-activation notice with default activation plan, and an adjacent structure based plan. Thus, for example, the EMFS is in control communication with the operation control command plan, which can be part of a control system, on the cloud, a local controller and combinations and variations of these, as well as the other configurations discussed in this Specification.

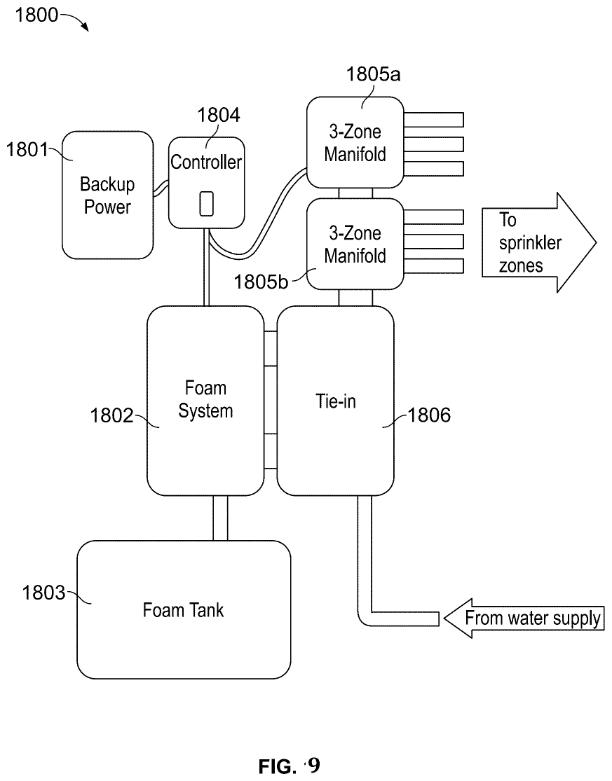

Turning to FIG. 9 there shown a schematic of a general embodiment of an EFMS 1800. This system can be a part of a coordinated wildfire management system for the protection of a community of structures. The EFMS 1800 has a power back up 1801, a controller 1804, a foam system 1802 and a foam tank 1803. Water from a water source, e.g., city water, public utility water is connected via a pipe to a tie-in unit 1806, that is in fluid communication with the foam system 1802. Water or a water-foam mix is flowed through a pipe from the tie-in unit 1806 to a first manifold 1805b and a second manifold 1805a. The manifolds distribute the water, or water-foam mixture through pipes to sprinkler heads. (The reference to “zones” in this figure refers to a group of particular sprinkler heads in the system, i.e., a zone of sprinkler heads, such as for example 5 sprinkler heads under the eve of the north side of the structure, and not the hydration zones as discussed with respect to an hydration plan.) The manifolds are modular, so that a system can have one, two (as shown), three, four or more modules depending upon the number of sprinkler heads used in the system. This EMFS can perform one or more, and all of the various functions of EMFS set forth in this Specification.

Embodiments of this EMFS have an operation control command plan for performing an operation plan. The operation plan, for example, can be one or more of a hydration plan, a lockout plan, a low line pressure plan, an auto-activation notice with default activation plan, and an adjacent structure based plan. Thus, for example, the EMFS is in control communication with the operation control command plan, which can be part of a control system, on the cloud, a local controller and combinations and variations of these, as well as the other configurations discussed in this Specification.

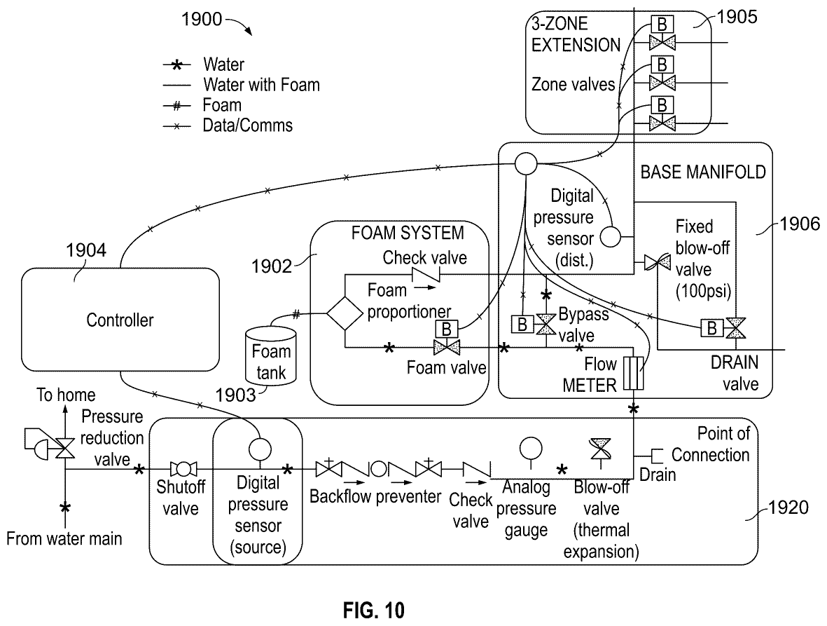

Turning to FIG. 10 there is shown a schematic of a general embodiment of an EFMS 1900. The system 1900 has controller 1904 that is in control communication with various components of the system as shown by the Data/comms lines. The system 1900 has a foam system 1902, with a foam tank 1903. The system 1900 has a base manifold 1906 (e.g., a tie-in), that integrates the foam system with the incoming water. The system 1900 has an incoming water system 1920. The system has a first manifold 1906 that distributes the water, or water-foam mixture to the sprinkler heads. (The reference to “zones” in this figure refers to a group of particular sprinkler heads in the system, i.e., a zone of sprinkler heads, such as for example 5 sprinkler heads under the eve of the north side of the structure, and not the hydration zones as discussed with respect to a hydration plan.)

The manifolds are modular, so that a system can have one, two (as shown), three, four or more modules depending upon the number of sprinkler heads used in the system. This EMFS can perform all of the various functions of EMFS set forth in this Specification.

Embodiments of this EMFS has an operation control command plan for performing an operation plan. The operation plan, for example, can be one or more of a hydration plan, a lockout plan, a low line pressure plan, an auto-activation notice with default activation plan, and an adjacent structure based plan. Thus, for example, the EMFS is in control communication with the operation control command plan, which can be part of a control system, on the cloud, a local controller and combinations and variations of these, as well as the other configurations discussed in this Specification.

In general, one or more, and preferably all of the EFMS have a lockout, an interlock plan, and both plans, as well as, combinations and variations of these. The lockout preferably is a control command operation plan for performing an operation lockout plan. Thus, the EFMS that are part of, or on a network, receive information, e.g., data, about conditions around and near the structure that EFMS is associated with and protects. This information could come any number of sources, for example, external moisture or hydration sensors, optical sensor and devices, other EMFSs, emergency networks, user input, first responder input, and water pressure sensors. This information can be provided to the control system, and based upon the algorithms and programing of the control system the control system, the local controller and combinations and variations of these, can shut down a particular EFMS.

In a preferred embodiment of lockout systems and methods, the control system having the lockout program resides on a cloud-based network system, and receives information and data from the EFMS that it is in control communication with the network, as well as, other sources of information. The network based control system having the lockout program is configured, based at least in part upon the received data and information, to perform one or more of and preferably all of the following functions: (i) lockout one or more EFMSs, and thus prevent that system from operating or stopping on going operation; (ii) remove the lockout from one or more of the locked out EFMSs, and thus allow that system's normal activation protocols to control the operation of that system; (iii) activate a locked out system. It is noted that in addition to the command control lockout control program, the control system can and preferably does have one or more of the other features of the network and control systems described in this Specification.

In an embodiment both the local controller and the cloud-based control systems have the lockout control command operation plan, i.e., the lockout programs and capabilities.

Thus, the control system, the local controller or both can receive one or more of the following information or data and balance this information to make a determination to automatically shut down and EFMS, i.e., lock the system out.

For example, the control system, the local controller or both, can receive information or data about the hydration level of combustibles, or moisture in the area adjacent to a first structure that an EFMS is associated with and protecting. The control system, the local controller or both, can receive information or data about the line pressure of the water line going into the first structure. The control system, the local controller or both, can receive information about the line pressure of other structures further removed from the first structure, but closer to an active fire. The control system, the local controller or both, can receive information about wind direction and wind speed. The control system, the local controller or both, can receive information about other EFMSs systems that are operating and that are closer to an active fire. The control system, the local controller or both, can also receive any of the other sources of information or data set forth in this Specification. Based on one or more of these types of information or data, the control system, the local controller or both, determine if the EFMS for the first structure should be shut down and locked out.

Examples of factors that the control system, the local controller or both may consider (e.g., the computer code, program or algorithm in the control command operation plan for performing an operation plan, such as a lock out plan, an interlock plan, or others, evaluates these factors using a processor and memory). This consideration in a preferred embodiment is conducted a balancing of the factors, based upon the risk or benefits presented by the presence or absence of various factors. In this manner the control system balances these factors as part of a multivariable component systems and activities for the management, mitigation, and suppression of wildfires. For example, these factors would include:
Hydration levels.
Water line pressure.
Status of internal fire suppression systems.
Status of the EFMS in an adjacent structure, and status of the EFMS in further away or more distance structures.
Status of internal fire suppression systems in an adjacent structure, and status of the internal fire suppression system in further away or more distant structures.
Status of peripheral systems, such as HVAC, lighting, security systems.
Increased hydration (e.g., at or above the level wetting that won't burn) of the area immediately around the first structure supports a lock out of the system.
Water pressure of the incoming water line falling below a pressure that is required for the operation of first responder's fire fighting equipment, supports a lock out of the system. If the pressure falls below a critical level, this factor may mandate a lock out, regardless of the other factors.
Operation of adjacent EFMSs and EFMSs that are located between the first structure and an active fire supports a lock out of the system.
Low hydration levels (e.g., dry conditions) around the first structure weighs against a lock out of the system.
A low number of, or the absence of any, EMFSs adjacent to or between the first structure and active fire weighs against a lock out of the system.
The proximity of the first structure to an evacuation route, e.g., the first structure is adjacent to, or on, an evacuation route, weighs against a lock out of the system.
The direction of the wind, moving the fire toward the first structure, weighs against a lock out of the system.
The activation of the EFMS in one or more adjacent or nearby structures.
The activation of an internal fire suppression system in one or more adjacent or nearby structures.
The detection of embers, by the EFMS, or by an EFMS in an adjacent structure, and by an EFMS in further away or more distance structures.
The activation of EFMS, an interior sprinkler system, or both, in structures directly adjacent to the first structure supports a lockout of the first structure's system, as the first structure will receive a cooling effect from the operation of the adjacent EFMSs.
The activation of interior fire sprinkler systems of the first structure supports a lockout of the system, this will assure that the internal system has sufficient water to operate properly.
The duration of time after that an adjacent structure EFMS, interior fire suppression system or both remains operation, could weigh in favor of lifting a lockout.
The detection of off gassing (which is a precursor to ignition) from materials in an area around the structure, by the EFMS at an adjacent structure, or by the EFMS at structure further away from the first structure.

The balancing of these and other factors can be based upon several factors, such as public policy, emergency management plans, rules or ordnances (state, local or federal), establish industry guidelines, and the capacity and nature of local infrastructure, e.g., the capabilities of the public water system.

The lock out of a system preferably is only for a limited time, and the lockout will be automatically lifted by the control system, the local controller or both, as conditions change, or the balance of the factors change. Further, the control system for the network of EFMSs can be configures so that the balancing of these factors takes place across an entire area, e.g., 10 Structures with EFMSs, 100 Structures with EFMSs, 500 Structures with EFMSs, 1,000 Structures with EFMSs, 2,000 Structures with EFMSs, and 10,000 structures with EFMSs. The network control system can thus, turn on and turn off individual EFMS based, at least in part upon, the received information and data and the predetermined balancing of these different factors.

Once the determination to lock out a particular EFMS is made by the control system, the control system automatically sends a control command to that EFMS, causing the local controller to lock out that system.

Preferably, the control system that makes these determinations, is based in the cloud. This control system can then send and receive control communication and information or data from the local controllers associated with each EFMS, as well as, external sensors, and other inputs, e.g., first responder, users, emergency management authorities.

The lock out could also be limited to switching the EFMS to an alternative water source, such a tank, fire truck, water tanker (e.g., truck, skid mounted container, rail car) or swimming pool.

In an embodiment of the present systems and methods, the system has a one, two, and preferably three fire suppression medium sub-systems, with each sub-system having a different fire suppression medium. These sub-systems can be stand-alone systems at a structure, each with their own control and communication system, they can be partially integrated, or preferably they can be an integral part of the EFMS, and can be fully integrated with and controlled by the control system for the EFMS.

In an embodiment of a three sub-system EFMS, the EFMS can be of the general type of any of the embodiments in this specification, including the Examples and Figures, and has three fire suppression medium sub-systems, the first sub-system is configured to provide water as the fire suppression medium; the second sub-system is configured to provide foam as the fire suppression medium, and the third sub-system is configured to provide a fire retardant as the fire suppression medium.

By way of example fire retardants can be any material, e.g., chemical composition, that alters the way in which the fire burns, such as by decreasing fire intensity, slowing the advance of the fire, and both. The materials preferably retain their fire retardant properties even after the water originally contained in the material has evaporated. It is understood that the water is primarily used to aid in the uniform distribution of the fire retardant over a predetermined area. Fire retardants can be long-term retardants, pre-treatment retardants and combinations of these, and others. Preferably, the fire retardants fall within the standards set forth by the United States Department of Agriculture, Forest Service Specification FS 5100-304d.

In general, fire retardants contain salts, such as agricultural fertilizers. Fire retardants are available as liquid or dry concentrates that are then mixed with water prior to distribution to a designated area. The subsystem, e.g., 2730, would perform this mixing (of water and concentrate retardant) and provided the mixture to the selector 2740.

Examples of the mix ratio (retardant concentrate to water) for commercially available fire retardants are set forth in Table 3.

TABLE 3

| Fire retardant | Mix Ratio | |
|---|---|---|
| Phos-Chek MVP-Fx | 0.96 | lbs/gal |
| Phos-Chek MVP-F | 0.95 | lbs/gal |
| Fortress FR-100 | 1.68 | lbs/gal |
| Fortress FR-105M | 1.68 | lbs/gal |
| Phos-Chek 259-Fx | 1.01 | lbs/gal |
| Phos-Chek LC-95A-R | 5.5:1 | (gal:gal) |
| Phos-Chek LC-95A-Fx | 5.5:1 | (gal:gal) |

Phos-Chek MVP-Fx contains 80-90% Monoammonium phosphate (CAS-No. 7722-76-1), 5-10% Diammonium phosphate (CAS-No. 7783-28-0) and less than 15% performance additives.

Phos-Chek MVP-F contains 75-85% Monoammonium phosphate (CAS-No. 7722-76-1), 8-12% Diammonium phosphate (CAS-No. 7783-28-0) and less than 15% performance additives.

In general fire retardants contain materials, such as Aqueous MgCl₂ solution, Ammonium polyphosphate solution, Attapulgus clay, Iron oxide, Monoammonium phosphate, Diammonium phosphate, Amorphous silica, and MgCl₂. The retardants can contain 70% or more, 75% or more, 80% or more, 85% or more of Aqueous MgCl₂ Solution, Ammonium polyphosphate solution, Monoammonium phosphate, Diammonium phosphate, amorphous silica, or MgCl₂ as the primary component of the retardant concentrate.

In general the retardant concentrate can be mixed with water in amounts of about 0.6:1 (dry weight lbs:gal water) to about 2.5:1 (lbs/gal); or from about 4:1 (liquid retardant gal:gal water) to about 7:1 liquid retardant gal:gal water).

It is understood that the embodiments of the Figures, as well as the various examples, and their components, can be used in whole or in part, with each other and with systems having an operation control command plan for performing an operation plan. The operation plan, for example, can be one or more of a hydration plan, a lockout plan, a low line pressure plan, an auto-activation notice with default activation plan, and an adjacent structure based plan. Further, these systems and components can be in communication with, and control communication with, one or more internal fire suppression systems.

### EXAMPLES

The following Examples are provided to illustrate various embodiments of systems, devices, methods, and uses of the present inventions. These Examples are for illustrative purposes, may be prophetic, and should not be view as, and do not otherwise limit the scope of the present inventions.

### Example 1

As part of the control commands for one or more EFMSs, the commands include an auto-activation notice with default activation plan (“auto-activation plan”). In general, this control command plan is configured to operate generally with three steps. 1) Upon an event (e.g., the detection of an initial threat from a wild fire, a determination of a risk factor, a change in a risk factor, etc.) the control system sends an automatic activation notice to one or more GUIs, the automatic activation notice includes a notice providing a time to activation. 2) The time to activation is counted down by the control system. 3) If the control system has not received an instruction to not activate the system by the end of the time to activation, e.g., the end of the countdown, the system will activate. The operation control command plan for the EMFS, can also include one or more of a hydration plan, a lockout plan, a low line pressure plan, and an adjacent structure based plan. In this manner one or more of these plans can be implement upon automatic activation.

### Example 2

An EFMS that is associated with a structure, e.g., a house, dwelling or business, and is in control communication with one or more GUI devices. The EFMS is part of an emergency management control network and system. The GUI device, that can be for example a cell phone, tablet, automobile displace monitor, or computer monitor. The GUI device is preferably external to the EFMS, e.g., it is not fixed to the wall of the structure, it is not physically attached to the components of the EFMS. More preferably the external GUI device is a remote device, located, or capable of being located any distance from the structure. (e.g., 100 ft, 1,000 yards, 1 mile, 2, miles, 500 miles, etc.) It being noted that the GUI device, preferably a second or additional device to the remote device, can be located on the structure.

The control system, which is in control communication with the EFMS has an auto-activation plan.

Upon a predetermined event (e.g., the detection of an initial threat from a wild fire, a low hydration level, a determination of a risk factor, a change in a risk factor, etc.) the control systems send to a GUI a notification signal (e.g., information, command) from the EMFS directly (e.g., radio, satellite, landline, cell phone), via the network, or both. The GUI receives the signal and the received information causes the GUI to display a first event notice, which can be, for example, a popup notice on a cell phone or tablet. The GUI is configured so that the first popup notice links to, and thus, displays when accessed, for example by touching or swiping the notice, a first detailed event screen. This first detailed event screen provides information about the event, and relevant fire conditions, and is configured to request and receive input from the user. The first popup notice, the first detailed event screen, and preferably both, in the notice provide information, among other things, that the EMFS will activate within a predetermined period of time (e.g., 5 min, 10 min, 15 min) if no action is taken by the user. Thus, upon sending of the first event popup notice the EMFS is configured to activate at a predetermined time, and will activate at that time, unless it receives a command to the contrary.

Thus, the EFMS upon, or simultaneously with, sending the notification signal, e.g., the signal causing the first popup notice, is in, or has been automatically set to, a default condition that the EFMS will activate and has set a time to activation, i.e., the countdown. The sources of information or data that constitute the event that the EFMS receives to cause the sending of the notification signal, determining and setting the time to activation, and setting the default activation condition can come from one or more sources. For example, the information or data can come from the network, from direct monitoring by sensors that are a part of the EFMS, historic data, derived data, predictive data and combinations and variations of these as well as other sources. The control system, using an control command auto-activation notice with default activation plan determined the time to activation based upon this information and data. Various factors based upon this information, are then used by the control system, which can be resident on the EFMS, remote, in the cloud, and combinations and variations of these, to automatically determine, set and start the time period countdown. Moreover, as events change, and new data and information are received by the control system the time period can be changed, a second notification signal, with a new count down time (either longer or shorter) can be sent to the GUI. One, two, three or more notification signals can be sent depending upon the nature of the changes to events. Each new, or update, popup from these notifications will preferably have a new, or updated, detailed event screen.

If the user does not advance to the first detailed event screen, e.g., the user does not take any action in response to the pop screen, the EFMS will automatically activate at the end of the count down. If the user advances to the first detailed event screen, but takes no action, i.e., does not input any command, the EFMS will also automatically activate.

Preferably, the first detailed event screen provides for the input of an activate now command (which will turn the EFMS on when received, and before the predetermined activation time), and a turn off activation. The detailed event screen can have other relevant or pertinent information as well.

### Example 3

In an embodiment of this parcel-by-parcel control system, the control system evaluates, the status of EFMSs and internal fire suppression systems at the parcel level, a with respect to each parcel. This evaluation includes an evaluation that a parcel does not have, or is not known to have, an EFMS, an internal fire suppression system or both. The control system, using an operation control command plan, determines the optimum EFMS and peripheral system unitization strategy and status (e.g., activate, locked out, vents open, automatic activation notice, etc.) on a parcel by parcel, PIN by PIN, level, and upgrades this parcel by parcel, PIN by PIN, utilization strategy, periodically, as new information, events and factors are received. Preferably, this updating is continuous.

### Example 4

A network and one or more EFMS on the network have a control command operation system configured for implementing a community based hydration plan. This system is a coordinated wildfire management system for the protection of a community of structures, and can be a part of a larger system for a larger community of structures. Turning to FIG. 15 there are shown three structures 100, 200, 300 each having an EFMS, and an internal sprinkler system. These structures are in a community which has an area 151. The structures receive their water from a public water line 400 flowing in the direct of the arrow. Each structure has its own water line 410, 420, 430 extending from line 400 and thus providing a source of water to the structure, and in particular, the EFMS and the internal sprinkler systems. Water lines 410, 420 and 430 each have a sensor 411, 421, 431, which can be a pressure sensor, a flow meter, or both, and water line 400 has a sensor 401, which can be a pressure sensor, flow meter or both. The internal sprinkler systems have sensors 412, 422, 432, which can be pressure sensors, flow sensors, or other means to determine that the system is operating. The EFMS have external sensors, e.g., 413, 423, 433, that determine or sense the moisture/hydration level of the combustible materials adjacent to and nearby the structure.

In operation, information from one or more than one, and preferably all of the sensors 401, 411, 421, 431, 412, 422, 432, 413, 423, 433 are transmitted over a network to the cloud-based control system, having the control program that has and preferably determines a hydration plan, based upon impute from the sensors, other networks and systems as well as, other sources and types of data and information discussed in this Specification. (As noted in this Specification, the control system can reside on the cloud, the control system can be local, the control system can be distributed between local and cloud systems and combinations and variation of these.)

The control system may also have a lock out control feature. Thus, for example the control system could lock out the EFMS for structure 200, if the EFMS system for structure 100, structure 300 or both were operating. Similarly, the controller could lock out the EFMS for any of the structures if the internal system was operating, and in particular if the internal system was operating and the line pressure for the incoming water was low, e.g., below a predetermined pressure to require shut down to the EFMS, when the internal system is operating.

### Example 5

A network and one or more EFMS on the network have a control command operation system configured for implementing a community based hydration plan. This system is a coordinated wildfire management system for the protection of a community of structures, and can be a part of a larger system for a larger community of structures. Turning to FIG. 15A there is shown a schematic of an embodiment of the system of Example 4, like numbers have like meanings. In the embodiment of FIG. 15A a pumper water truck 480 is connected by line 483, to a fixed line 481 by way of value and connector 482. The pumper water truck can be for example: a fire truck, a water tanker truck with pumps, a skid mounted water tank with pumps, or a rail car with pumps. The pumps for the water holding vehicle or skid, are preferably on or a part of the truck or vehicle or skid. The pumps however can be provided as a separate unit. The fixed line 481 can be, for example, a tie-in or pipe and valve configuration to the city water line 400, it can be a fire hydrant, or it can be a separate set of lines feeding the EFMS, and combinations and variations of these.

In this embodiment the pumper water truck is used to supply water under pressure to line 400. In this manner these EFMS, the interior systems and preferably both, for all three structures 100, 200, 300, have sufficient water flow and pressure to be operated effectively.

Although a single water pumper truck 480 is shown, it is to be understood that multiple truck can be used, and can be connected to the same line 481, or to other lines.

### Example 6

A network and one or more EFMS on the network have a control command operation system configured for implementing a community based hydration plan. This system is a coordinated wildfire management system for the protection of a community of structures, and can be a part of a larger system for a larger community of structures. Turning to FIG. 15B there is shown a schematic of an embodiment of the system of Example 4, like numbers have like meanings. In the embodiment of FIG. 15B a pumper water truck 480 is connected by line 483, to line 481 by way of value and connector 482. The pumper water truck can be for example: a fire truck, a water tanker truck with pumps, a skid mounted water tank with pumps, or a rail car with pumps. The pumps for the water holding vehicle or skid, are preferably on or a part of the truck or vehicle or skid. The pumps however can be provided as a separate unit.

Line 481 and line 484 can be fixed, e.g., in ground, or can be temporary, and combinations of these. In a preferred embodiment line 481 is a fixed line and connector 482 is of the type found on a conventional fire hydrant, and line 484 is fixed and buried under the ground.

In this embodiment the pumper water truck is used to supply water under pressure to line 484. In this embodiment line 481 does not feed, or otherwise connect to, line 400. Line 481 connects to line 484, which in turn connects to line 410, 420 and 430. In this manner the EFMS, the interior systems and preferably both, for all three structures 100, 200, 300, have sufficient water flow and pressure to be operated effectively.

Although a single water pumper truck 480 is shown, it is to be understood that multiple truck can be used, and can be connected to the same line 481, or to other lines.

### Example 7

A network and one or more EFMS on the network have a control command operation system configured for implementing a community based hydration plan. This system is a coordinated wildfire management system for the protection of a community of structures, and can be a part of a larger system for a larger community of structures. Turning to FIG. 15C there is shown a schematic of an embodiment of the system of Example 4, like numbers have like meanings.

In this embodiment the community has several sprinkler towers 492, 493, 494, 495, 496. The spray pattern and area of coverage for the sprinkler 492 is shown by dashed lines. It being understood that the area of converge can be a uniform 360 degrees, or can be smaller targeted areas. Each of the sprinkler towers 493, 494, 495, 496 has similar spray patterns and area of coverage (dash lines have been omitted to simply the drawings) to tower 492.

The sprinkler towers are located along a roadway 499, an easement, a path, etc., that is adjacent to the structure's property. In this manner the sprinkler towers can provide protection to an evacuation route, roadway 499, and the property and portion of the structure facing the evacuation route.

The water towers can be portable, temporary, semi-perinate or perinate. They can have their own water system, be feed by the fire hydrant system, the structure's water supply system, a pumper truck and combinations and variations of these. The water sprinkler towers are controlled by the control system, and implement the hydration plan.

### Example 8

A network and one or more EFMS on the network have a control command operation system configured for implementing a community based hydration plan. Turning to FIG. 15D, for example, other embodiments may also be used for this Example, there is shown a schematic of an embodiment of the system of Example 4, like numbers have like meanings. In the embodiment of FIG. 15D a pumper water truck 480 is connected by line 483, to a line 481 by way of value and connector 482. The pumper water truck can be for example: a fire truck, a water tanker truck with pumps, a skid mounted water tank with pumps, or a rail car with pumps. The pumps for the water holding vehicle or skid, are preferably on or a part of the truck or vehicle or skid. The pumps however can be provided as a separate unit. The line 481 and connector 482 can be of a type that is generally configured like a conventional fire hydrant, including the same type of connectors.

In this embodiment the pumper water truck is used to supply water under pressure to line 493. In this embodiment line 481 does not feed line 400. Line 403 connects to line 493a and 493b. (In embodiments, line 481 can feed line 400.) Lines 493a and 493b are connect to a sprinkler tower systems 490, 491 (e.g., fixed, portable, mobile) respectively. In this manner the tower systems have sufficient water flow, pressure and areas of coverage, to be operated effectively for all three structures 100, 200, 300. Line 493c would be for a third sprinkler tower system not shown. The third sprinkler tower system could be used to provide protection to additional structures, also not shown, or provide additional protection to one or more of structures 100, 200 or 300.

Although a single water pumper truck 480 is shown, it is to be understood that multiple truck can be used, and can be connected to the same line 481, or to other lines.

### Example 9

The embodiments the forgoing examples may be used with and in combination with each other.

### Example 10

The embodiments of FIGS. 15B, 15C and 15D can be configured to be operated by a local control system that can be cloud based, or based on an EMS server. In this configuration one, two, three or more, ten, ten or more pumper trucks (each with its respective sprinkler towers) are configured in an area at risk for fire. This group of pumper-truck-tower-systems can be controlled by a firefighter at the area, or remotely. Each of these pumper-truck-tower-systems can have one, two, three or more sprinkler tower systems associated with each pumper truck. This configuration greatly reduces the number of firefighting personnel that are need to be on the ground in the area at risk. For example, if one or two firefighters are need for each pumper truck, depending upon the size and number of sprinkler tower systems for each pumper truck, the configuration can reduce the number of firefighters needed to effectively protect the area at risk by 5 or more, 6 or more 7 or more, 10 or more, from 5 to 12, and fewer or greater numbers.

Thus, it is believed that each embodiment of the configuration of the pumper-truck-tower-systems (e.g., FIGS. 15B, 15C and 15D), is equal to 3 to 12 fire fighter equivalents, 4 to 7 fire fighter equivalents, 5 to 10 firefighter equivalents. A firefighter equivalent is the number of firefights that are no longer necessary, and thus replaced by the pumper-truck-tower-systems, to safely and effectively provide the same level of fire protection for a specific area.

Thus, these pumper-truck-tower-systems can be a significant force multiplier, and also greatly reduce the risks to fire fighters.

### Example 11

In an embodiment one or more of an EFMS, the network, or both have a control command operation plan for performing a low line pressure plan, e.g., the lockout is based at least in part upon water line pressure. In an embodiment of the low line pressure plan the network and one or more EFMS on the network have a control command operation plan for performing an operation lockout plan that is based primarily upon water pressure in one or more the water lines feeding a structure, or zone or area of structures. By primarily, it is meant that this factor is most significant, or most heavily weighted in the algorithm. In an embodiment of the low line pressure plan the water pressure in the water line is the only factor relied upon by command operation plan for performing an operation lockout plan. Preferably, this low line pressure plan is in conjunction with, and compatible with, a hydration plan for a community of structures that uses the minimal amount of water, both from a volume and a flow rate criteria, to protect the community from wildfire, e.g., prevent ignition of structures and nearby fuel sources, e.g., vegetation.

### Example 12

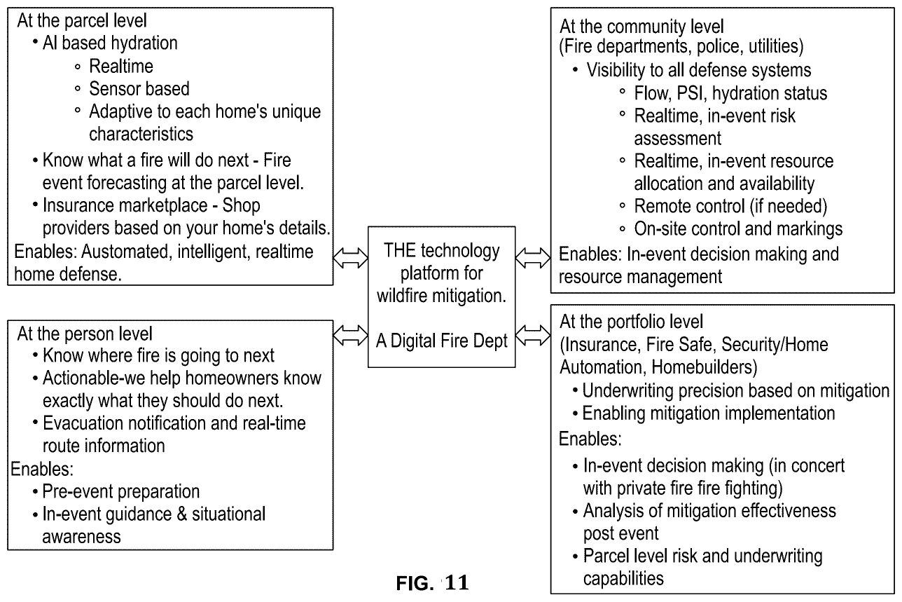

Turning to FIG. 11 there is shown a flow chart showing the operation and benefits of an embodiment of a control command operation plan for a network and EFMSs. This system includes a coordinated wildfire management system for the protection of a community of structures.

### Example 13

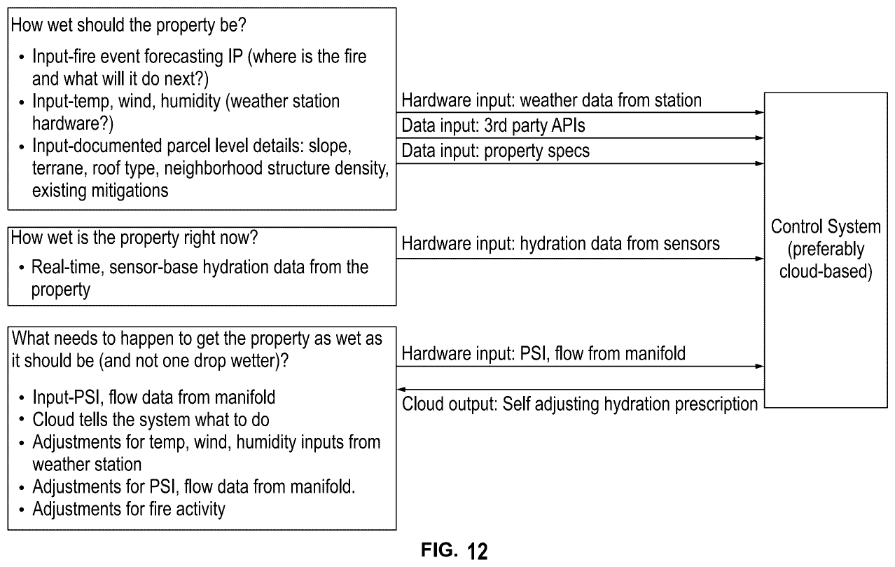

Turning to FIG. 12 there is shown a flow chart showing the operation and benefits of an embodiment of a control command operation plan for performing a hydration plan. This system includes a coordinated wildfire management system for the protection of a community of structures.

### Example 14

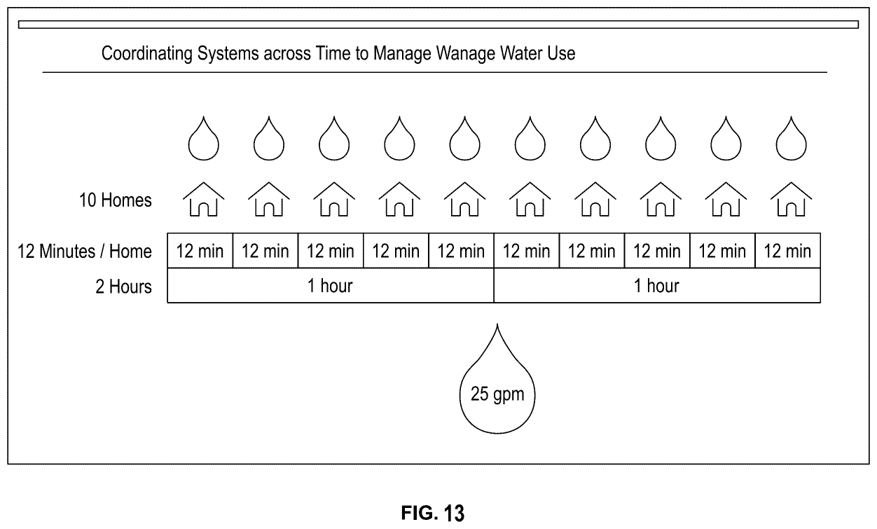

Turning to FIG. 13 there is shown a flow chart showing the operation a control command operation plan for optimizing the use of water in a zone of 10 home. This system is a part of a coordinated wildfire management system for the protection of a community of structures.

### Example 15

In embodiments the control system has several control command operation plans and methods that can be used to activate the EFMS and control and regulate the operation of EFMS in several operation plans. In a preferred embodiments these plans include a hydration plan for a community, that provides for the use of a hydration plan for a community of structures that uses the minimal amount of water, both from a volume and a flow rate criteria, to protect the community from wildfire, e.g., prevent ignition of structures and near fuel sources, e.g., vegetation. These embodiments include one or more of the following, as well as, combinations and variations of these.
Moisture sensors are located in the area adjacent to the structure. The moisture sensors send data to the control system that can be used to cause the activation of the EMFS. That data can also be used to send notifications to users, providing moisture levels, recommendations to activate, recommendation to change the EFMS's hydration plan, the fire mitigation plan (exterior sprinkler operation when fire is imminent) or both.
In an embodiment, the data and the information from the moisture sensors are evaluated by the control system in combination with line pressure of water lines feeding the structures. In this manner, the control system can adjust the hydration plan based upon moisture levels and line pressure, can lock out a system or area if moisture levels are high and line pressure is low, or can evaluate moisture levels in a predetermined area and line pressure in that predetermined area, and optimize EFMS to maximize line pressure (e.g., maintain line pressure at highest levels possible while obtaining effective mitigation of wildfire for the predetermined area).
In an embodiment, the data and the information from the motion sensors are evaluated by the control system in combination with line pressure of water lines feeding the structures. This monitoring can be on a structure-by-structure basis and for a predetermined area. The information about moisture levels and line pressure is provided to Fire Departments or other emergency management offices, and based upon the information, (including recommendations from the control system) specific EFMS can be locked out.
In an embodiment the operation of interior sprinkler systems (e.g., NPA13 D systems) is configured to be operated in conjunction with an EFMS. Thus, for example, the activation of the interior sprinkler system can cause the exterior system to lock out. This lock out operation can be based upon line pressure in the interior system, indicating operation of the interior system, and sending a lock out signal to the EFMS. In a preferred embodiment, upon activation of the interior system the control system monitors the line pressure in the interior system, as well as, the line pressure feeding the structure, and in embodiments, also the line pressure feeding a predetermined area where the structure is located. The control system can then make the determinations, based upon one or more of the line pressure in the interior sprinkler, the line pressure feeding the structure, the line pressure in the area, as well as, moisture levels, to lock out the EFMS. In addition to only a lock out option, the control system can modify the hydration plan, the fire mitigation plan (exterior sprinkler operation when fire is imminent) or both for the EFMS.
In an embodiment the control system can monitor and determine the advantage of the cooling effect to adjacent structures when the interior system is activated in a structure. This can also be an effect from the EFMS being activated in the adjacent structure. The control system can use this cooling effect to adjust, lock out, and regulate the EFMS in the adjacent structures.
In an embodiment there can be a flow sensor on the internal sprinkler system that determines when the system is operating. This information and data about the activation and operation of the interior systems can be sent wirelessly, (e.g., cellular, satellite) or via wired internet connection to a control system that then can make calculations, determination and provide notice and instructions based upon this information. Thus, for example, the control system can provide instruction to the EFMS, notice to the structure owner, Emergency Management or both.
In an embodiment the sensor that determines activation of the interior system operates with the EFMS along the lines of a dead man switch. Thus, the sensor sends a signal that permits the EFMS to operate when the interior system is not operating, upon operation of the interior system this signal stops, and thus locks out the EFMS.

### Example 16

In an embodiment there is a method of installing an EMFS control module that would use an existing outdoor irrigation systems (e.g., lawn sprinklers) as the sprinkler heads, and to deliver the fire suppression material (e.g., water) upon activation of the EMFS, for either hydration plans or fire suppression. In this embodiment additional sprinkler head and piping, such as roof top and eve sprinkler heads, can be added. In this embodiment the cost of installation of the EFMS is greatly reduced. The EMFS controller is mounted in the structure (e.g., adjacent to the lawn sprinkler controller). There is a bypass and cut off that permits the EMFS to override the law sprinkler controller and operate the system. The EFMS has one or more of the control communication features of the EFMS set forth in this Specification, including such as a hydration plan, a lockout plan, a low line pressure plan, an adjacent structure based plan, and an auto-activation notice with default activation plan.

### Example 17

In an embodiment of these systems that use the existing irrigation systems for piping and sprinkler heads of the EFMS, there can be a foam general system that is also used. The foam generation systems can be in fluid communication (e.g., pipes) with the sprinkler systems and having valves (e.g., cut offs, automatic valves) that permit the foam system to generate foam and flow the foam through the lawn sprinkler heads. Thus, for example only the controller for EFMS can be used and configured to by-pass or turn off the power the landscape irrigation system (e.g., law sprinklers) controller and then operate the landscape irrigation system as an EFMS. In an embodiment both the EMFS controller and manifold are integrated into the landscape irrigation system. The manifold connects below landscape irrigation valves and the EFMS controller turns off power to landscape irrigation controller so that the landscape irrigation valves do not open.

### Example 18

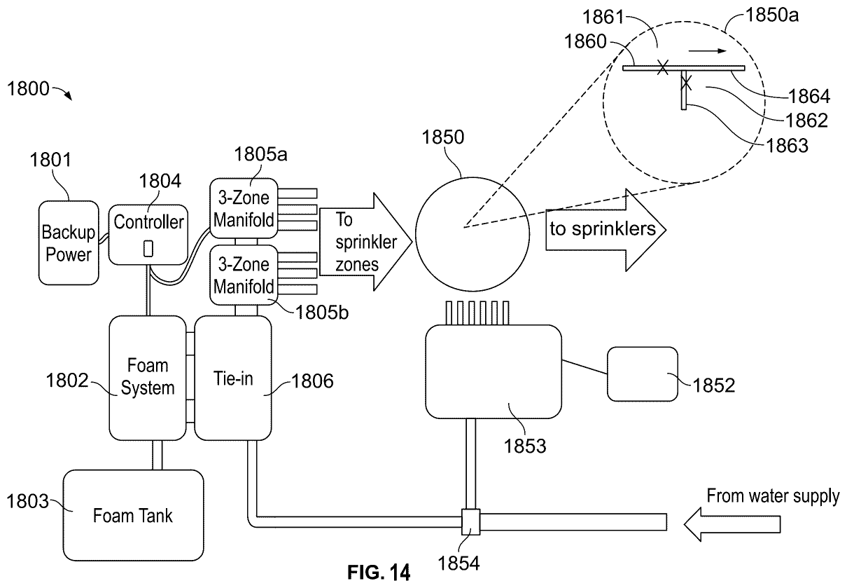

Turning to FIG. 14 there shown a schematic of an EFMS 1800 that utilizes the existing landscape irrigation system. This system can be part of a coordinated wildfire management system for the protection of a community of structures. The EFMS 1800 has a power back up 1801, a controller 1804, a foam system 1802 and a foam tank 1803. Water from a water source, e.g., city water, public utility water is connected via a pipe to a tie-in unit 1806, that is in fluid communication with the foam system 1802. Water or a water-foam mix is flowed through a pipe from the tie-in unit 1806 to a first manifold 1805b and a second manifold 1805a. The manifolds distribute the water, or water-foam mixture through pipes to sprinkler heads. (The reference to “zones” in this figure refers to a group of particular sprinkler heads in the system, i.e., a zone of sprinkler heads, such as for example 5 sprinkler heads under the eve of the north side of the structure, and not the hydration zones as discussed with respect to a hydration plan.) The manifolds are modular, so that a system can have one, two (as shown), three, four or more modules depending upon the number of sprinkler heads used in the system. This EMFS can perform all of the various functions of EMFS set forth in this Specification.

This EMFS has, is in control communication with a control system that has an operation control command plan for performing operation plans, such as one or more of a hydration plan, a lockout plan, a low line pressure plan, an adjacent structure based plan, an auto-activation notice with default activation plan. The control system can be in the controller 1804, in a controller on the cloud, or combinations of these. The control system operates the one or more operation control command plans.

The operation control command plans, and thus the plan which they provide, can be updated, for example, via the cloud, via the network, locally and combinations and variations of these.

The EMFS system 1800 utilizes the existing piping and sprinklers for a landscape irrigation system. The landscape irrigation system has a controller 1852 and manifold 1853, and pipes and sprinkler heads (not shown). An automatic 3-way valve 1854 is controlled by the controller 1804 of the EMFS. Upon activation of the EFMS the controller 1804 operates the valve 1854 to direct the flow of water to the EMFS and not to the irrigation system manifold 1853. The control 1804 can also turn off the power to the control 1852 upon activation of the EFMS.

The fire suppression material (e.g., water, foam, water-foam mix) is flowed to a series of individual connection assemblies, where the lines from the EFMS flow into the lines (pipes) for the landscape irrigation system, collectively shown as 1850. An example of an individual connection assembly is shown in call out circle 1850a. Thus, there is a line from the EFMS 1860 that is connected at a T joint or Y joint with the line 1863 from the irrigation manifold 1853. Thus, both line 1860 and 1863 are connected to line 1863 (or pipe) which goes to the irrigation systems sprinkler heads. Preferably check valves 1861 and 1862 are present to prevent backflow into the non-operating system.

### Example 19

In an embodiment, the EMFS manifold(s) 1805a are not used. In this embodiment the line from the tie-in 1806 is attached directly to manifold 1853 of the irrigation system. Thus, the EFMS utilizes the existing manifold 1853 of the irrigation system. Further, in this manner connectors 1850 are also not needed.

### Example 20

In embodiments the EFMS is an integrated system that operates and controls other devices and systems associated with the structure. Thus, in addition to having an operation control command plan for performing operation plans, such as one or more of a hydration plan, a lockout plan, a low line pressure plan, an adjacent structure based plan, an auto-activation notice with default activation plan, the EFMS can have operation control command plans and related hardware for one or more of the following, and combinations and variations of these.
managing HVAC systems in structures, such as control communications to a thermostat or breaker to turn off the HVAC system. shutting off electrical panels in a structure. In an embodiment the HVAC system can be configured to vent the structure to prevent, or mitigate, the amount of smoke that enters the structure.
turning on emergency circuits in emergency panels
managing the temperature in the refrigerator to evacuation mode
shutting off propane to a structure
closing garage doors (embers commonly get inside garages or under garage doors and burn homes during fire)
turning on inside and outside lights to a structure. (it is very dark during a fire and turning on lights can aid in firefighting)
arming all security alarms in the event of a fire and evacuation. This will help prevent homes or businesses from being looted, after the structures and area have been evacuated
managing and receiving information and data from anything in the structure that connects to a weather station and any downstream device that is regulated by a weather station that connects to Frontline data
managing smart charging to homes
managing, autonomous, non-autonomous, semi autonomous vehicles. planes, helicopters, drones, cars, boats
managing and deploying fire blankets that wrap over structures when a fire comes. The blankets can be gravity deployed or deployed by a powered device, electrical or pneumatic. The blankets can be deployed before, preferably after, initial wetting by the system, and wetting can continue after deployment.
managing and deploying automatic fire shutters that shut over windows or doors. The shutters can be gravity deployed or deployed by a powered device, electrical or pneumatic. The shutters can be deployed before, preferably after, initial wetting by the system, and wetting can continue after deployment.
shutting off oil and gas lines, for each structure, for an area or zones of structures, and combinations and variations of these.
turning off password protection to routers by switching them into a emergency mode that firefighters can then use to enhance internet communication during a fire
Pool architecture-a valve that closes the intake from a pool filter during a fire. Under certain circumstances, this would allow the pool water to be drawn solely from the drain at bottom of the pool, as opposed to also pulling off filter box 12″ from surface level and causing air to enter lines after the top 12″ of pool water is drawn down

### Example 21

In embodiments, communication towers, such as cell towers, radio towers, etc., have an EFMS.

### Example 22

In embodiments, major electrical power line towers or polls have EFMS.

### Example 23

In embodiments, structures and areas that house electrical power transformers, and communication hubs, such as internet hub have an EFMS. In the case of these electrical and internet structures and areas, the fire mitigation material should be suitable for use on electronics.

### Example 24

In an embodiment the system is configure to automatically, or upon instructions from the use, select and use a particular type of fire suppression material. Thus, the user, the control system, or both can select from one or more of water, foam, water and foam, another pre-mixed fire retardant, mechanical protection such as fire blankets and combinations and variation of these. Different materials can be used at different times, and for different risk factors, and these materials can each be used alone or in combination, and in serial or parallel sequences.

### Example 25

Historic, actual, predictive, and derived hydration level data and information, and combinations and variations of these is used to determine the configuration of an EMFS. In this manner the hydration level data and information can form a basis in whole or part, to determine the number and placement of sprinkler heads, the amount of fire suppression material to be stored in the system.

Predictive hydration level data and information can be used to determined modifications that may be need to existing EMFS, to future, e.g., increased needs of the system to protect the structure. Thus, for example additional sprinkler heads, large capacity storage tanks for foam, could be recommended by the control system, for addition to the system.

Embodiments of the EFMS, including any of the Examples, having one, two, tens, and hundreds, of individual structures and individual EMFS. These systems form a platform as a distributed network and based upon hydration data and information, historic, actual, derived, predicted, and combinations and variations of these, the platform determines optimum strategies for the use of available water to increase hydration levels in a manner that is optimum for the platform.

### Example 26

The embodiments of the EFMS, including any of the Examples provide notifications to individuals, such as on hand held devices, fire crews and emergency management teams. The systems are also configured to receive input and control compunctions from one or more of these groups.

### Example 27

Embodiments of the EFMS, including any of the Examples, are reconfigured and adapted for use with, as a part of, or integrated with, an internal fire suppress systems for the protection of the interior of structures. These internal systems can be integrated with, and preferable are a part of the distributed network of EMFS. The internal systems may rely upon the same source of fire mitigation material as the EMFS for the structure or they may have a completely separate source. Further, there may be a common back up source of fire suppression material that can be used, if needed, by both the EMFS and internal system.

The internal systems can similarly provide and receive information, communication and control communication from users, e.g., home owner, emergency management personal.

### Example 28

A satellite system is configured to provide information to, and to manage embodiments of the EFMS, including any of the Examples.

### Example 29

A system of drones, alone or in conjunction with, or without, the satellite system of Example 33, is configured to provide information to, and to manage embodiments of the EFMS, including any of the Examples.

### Example 30

Embodiments of the EFMS having hydration plans and hydration control commands, including any embodiments of the Examples having hydration plans, can have and can maintain predetermined condition based hydration levels as shown in Table 1.

TABLE 1
Hydration levels to be maintained by EMFS (Hydration
Level as soil % water content by weight)

| | Minimal | Recommended | Optimum |
|---|---|---|---|
| | Hydration level | hydration level | hydration level |
| HlZ0 | 10-15% | 25% | 35+% |
| HlZ1 | 5%-10% | 20-25% | 25+% |
| HlZ2 | 5%-10% | 10-15% | 20-25% |

Hydration levels are by way of example and are for high-risk fire conditions

### Example 31

Embodiments of the EFMS having hydration plans and hydration control commands, including any embodiments of the Examples having hydration plans, can provide hydration amounts and rates based upon predetermined conditions, e.g., a wildfire event, as shown in Table 2.

TABLE 2
Hydration amounts and Timing in Face of Wildfire Event

| | Primary Hydration | Replenishment |
|---|---|---|
| | amount | Hydration amount |
| HlZ0 | 1″ over 24 hours | 0.5″ per each 24 hours |
| | | after primary hydration |
| HlZ1 | 0.25″ over 24 hours | 0.13″ per each 24 hours |
| | | after primary hydration |

### Example 32

Embodiments of the EFMS, including any of the Examples, have discrete “scenes” or “modes” in the controller firmware of the EFMS controller, or in the control system in the cloud, or both, that act according to the exposure of the property, e.g., risk exposure, and then put the hydration plan into action, e.g., implement the hydration plan through the hydration control commands. For example, one mode may be a red flag warning mode, another a utility shutdown, another an evacuation mode, another an Imminent fire mode, another a dry fuel moisture seasonal activation mode. There would be others that align with exposure (both real and perceived exposure, as well as, actual, predictive and derived exposure).

These modes could be triggered manually by selection of the user on their app or at their controller GUI located at the property; they can also be activated automatically by the integrated/network systems control system and software ingesting data (e.g., receiving data and information, whether from push, pull, or combinations of these and other ways of receiving data and information into the control systems) that is relevant to a certain property or properties, and then selecting the appropriate mode of protection; and combinations and variations of these manual and automatic modes. For example, an algorithm, e.g., logic on a controller, is configured such that if data is ingested indicating low fuel moistures for an area, then it can trigger activation of the EFMS in that area (such as at night when it will not interrupt the homeowner). The homeowner can opt into this feature on their app or an insurer or fire service can also opt in on behalf of their portfolio or their service area. The system may run all zones or select certain zones.

In this manner the use of hydration is coupled with exposure risks based upon actual, historic, predictive and derived data to protect and mitigate the risk to the structure from wildfire.

Additionally, the identification of the exposure (e.g., risk level, risk factors) and selection of data that is operable for the activation of systems is an embodiment of the present systems and methods. Selecting single or multiple data sources that determine fuel moisture, or fire exposure (ground based, satellite based, actual perimeters, spread modeling of where a fire can travel and expose, weather variables, etc.) are all integral in determining exposure in real time, actual, derived and predictive approaches.

### Example 33

Embodiments of the EFMS having a hydration plan, and hydration control commands, including any of the embodiments of the Examples, can be configure for operation in a manner that makes, and maintains, the environment around the structure to be too wet to burn.

Thus, HIZ0 is five feet from the outer walls of the structure being protected, and has a footprint that follows the footprint of the structure. HIZ1 is adjacent to the outer edge of HIZ0 and extends outwardly therefrom to a distance that is 30 feet from the structure (e.g., HIZ1 starts at 5 feet away from the structure, i.e., adject to HIZ0, and extends 25 additional feet away from the structure). The system has two types of sprinkler heads that provide two patterns, small and large. The small patterns and the large patterns completely overlap over HIZ0, i.e., 100% overlap of HIZ0. The small patterns and the large patterns can also have a 60-70%, or greater, overlap for the entire protected area around the structure.

In exposures, e.g., risk factor, where ambers are present or likely to be present, a preferred wetting rate of about 1 inch of precipitation in 24 hours is provided to HIZ0I and HIZ1 receives about 0.25 inches of precipitation in 24 hours.

The system can also be configured to apply 0.75 inches, about 1.25 inches, about 1.5 inches, and about 2 inches, of precipitation per 24 hours to HIZ0. The system can also be configured to apply about 0.5 inches, about 0.75 inches, and about 1 inch of precipitation per 24 hours to HIZ1. Combinations and variations of these precipitation rates are contemplated. For example, depending on conditions and size of the zones, lower HIZ0 rates may be used in conjunction with higher HIZ1 rates. These rates, as well as, combinations and variations of them can also be used in a 3 zone system.

### Example 34

Hydration plan control commands can have one or more different hydration plans. These hydration plans can be implemented by the control system executing the hydration plan control commands, and operating the EMFS to hydrate the zones surrounding a structure.

The hydration plans can have a series of operation cycles, or cycles, when the EFMS is operating and delivering water to the zones.

The usage rate of water during operation of a hydration plan can be about 25 gpm during a wetting cycle.

During fire seasons, before an actual fire event, prewetting hydration plans can be implemented. In these prewetting hydration plans, for example, three to four hydration cycles, i.e., operation of the EMFS to wet the zones, occur 1 to 2 times a week, with each cycle providing about 0.25% the amount of full hydration, e.g., ¼ inch of precipitation in 24 hours, where full hydration is 1 inch in 24 hours.

Maintenance hydration plans can be used to address evaporation, and in particular during high levels of evaporation. In these maintenance hydration plans, for example, about 6 hydration cycles, i.e., operation of the EMFS to wet the zones, occur in a 24 hours period, with the total wetting of all 6 cycles being about 50% the amount of full hydration, e.g., ½ inch of precipitation in 24 hours, where full hydration is 1 inch in 24 hours.

During a fire event, e.g., ambers present, active fire within predetermined distance, evacuation order, etc., an in-event soak, or soak, hydration plan can be used. In these soak hydration plans, for example, about 12 hydration cycles, i.e., operation of the EMFS to wet the zones, occur in a 24 hours period, with the total wetting of all 12 cycles being about 100% the amount of full hydration, e.g., 1 inch of precipitation in 24 hours, where full hydration is 1 inch in 24 hours.

In a preferred embodiment the control system has all three types of hydration plans, and can automatically switch from the operation of one plan to the next based in part of information and data provided to the control systems over the network.

### Example 35

For the implementation of hydration plans, the fire suppression material, which as used in a hydration plan, would be considered the hydration material, can be water, a combination of water and foam, and foam. In a preferred embodiment, during an operating cycle, the hydration material is initially a water foam combination. For example, a 1:400 solution (foam:water by volume) of class A fire fighting foam approved by the USFS. This foam solution helps to break the surface tension of the water to accelerate absorption into vegetation and combustible fuels. The solution is preferably biodegradable, non-toxic, and requires no cleanup. The solution would be delivered preferably during the first ⅓ of the cycle, with the last ⅔ of the cycle being water.

### Example 36

In an embodiment of in an interlock plan, the operation control command plan is configured to activate the EFMS at a structure, upon the activation of an internal fire suppression system at an adjacent structure.

### Example 37

In an embodiment of in an operation plan, including an interlock plan, the operation control command plan is configured to close vents, preferably all vents, in an HVAC system, upon one or more of detection of embers, the EFMS at a structure, upon the activation of an internal fire suppression system at an adjacent structure.

### Example 38

In an embodiment the control system having an operation control command plans for performing several operation plans, actively manages one, two, three or more, five or more, 10 or more, 100 or more, EFMS, with each EFMS associated with a structure and further with each such EFMS associated with the property identification number (PIN) for the parcel of land where the structure is located. A PIN is a number that is assigned to a parcel of real property (i.e., land). PIN is a unique identification code, typically having about 8 to 10 digits, but can have more or less. PINs are unique for every parcel of land in any given area or jurisdiction, can are assigned by the government, for example by taxing authorities. PINs can also be referred to as Property Tax ID Number, Folio Number, Parcel ID Number, as well as other terms used to describe this unique identification number.

The control system for each PIN receives relevant information about a wildfire, status of EFMS, internal fire suppression systems, and other factors and events, the control system can such real time, raw data to created determine data and predicative data, as well as balancing factors to determine an event. From this the control system for a parcel using the operation control command plan performs the various operation plans. Preferably, the control system does this for all EFMS that the control system is control communication with, which EFMS are in a determined area, e.g., an area under risk of an approaching wildfire. In this manner the control system determines an optimum plan for the activation, lockout, interlock of the EFMS and the peripheral system.

This parcel by parcel, PIN by PIN, manner of control can be viewed as controlling each pixel in a monitor. It being understood that the more parcels, for a particular area, that the control system is receiving information about, and the more EFMSs in that area, the better the optimization of the utilization of the EFMSs in that area will be. In configurations, and dependent on such things as specific location of the parcel, distribution of the EFMS, the presence of natural barriers and wind speed, optimization can be obtained by receiving parcel by parcel information (and having EFMS) on 5% or more of the parcels in the area, 10% or more of the parcels in the area, 25% or more of the parcels in the area, 50% or more of the parcels in the area, and 70% or more of the parcels in the area.

### Example 38A

In an embodiment of this parcel-by-parcel control system, the control system evaluates, one, two, three or more of: water availability at the parcel level, amber fall out at the parcel level, location of the fire at the parcel level, wind speed, wind direction at a parcel level; hydration at a parcel level. The control system, using an operation control command plan, determines the optimum EFMS and peripheral system unitization strategy and status (e.g., activate, locked out, vents open, automatic activation notice, etc.) on a parcel by parcel, PIN by PIN, level, and upgrades this parcel by parcel, PIN by PIN, utilization strategy, periodically, as new information, events and factors are received.

### Example 38B

In an embodiment of this parcel-by-parcel control system, the control system evaluates, the status of EFMSs and internal fire suppression systems at the parcel level, a with respect to each parcel. This evaluation includes an evaluation that a parcel does not have, or is not known to have, an EFMS, an internal fire suppression system or both. The control system, using an operation control command plan, determines the optimum EFMS and peripheral system unitization strategy and status (e.g., activate, locked out, vents open, automatic activation notice, etc.) on a parcel by parcel, PIN by PIN, level, and upgrades this parcel by parcel, PIN by PIN, utilization strategy, periodically, as new information, events and factors are received. Preferably, this updating is continuous.

### Example 38C

In an embodiment of this parcel-by-parcel control system, the control system evaluates, one, two, three, four, or more, of water availability at the parcel level, amber fall out at the parcel level, hydration level on at the parcel level, location of the fire at a parcel level, wind speed and wind direction at a parcel level, the status of EFMSs at the parcel level, and the status of internal fire suppression systems at the parcel level. This evaluation includes an evaluation that a parcel does not have, or is not known to have, an EFMS. The control system, using an operation control command plan, determines the optimum EFMS and peripheral system unitization strategy and status (e.g., activate, locked out, vents open, automatic activation notice, etc.) on a parcel by parcel, PIN by PIN, level, and upgrades this parcel by parcel, PIN by PIN, utilization strategy, periodically, as new information, events and factors are received. Preferably, this updating is continuous.

### Example 39

A control system that is cloud based is configured to interface with one or more peripheral devices, and establish control communication with these peripheral devices. This control system is also configured to interface with the other embodiments of control systems and networks set forth in this specification. Preferably this control system is a part of, or a feature of, the other embodiments of control systems and networks set forth in this specification. The user preferably is provided menus on a remote control and communication device GUI, such as a smart phone or a tablet, and interfaces with the peripheral device through this control system or a network.

### Example 40

In an embodiment of an automated adaptive hydration plan, and its development, the control system determines a risk of the wildfire to the community of structures, e.g., the area depicted in FIG. 15, entire area depicted in FIG. 1A, or just a collection of structures, such as the structures along street 111 in FIG. 1A. In being understood that the area can encompass, and preferably does encompass an entire community, plan, subdivision of structures, and can have 5 or more structures, 10 or more structures, 25 or more structures and 100 or more structures. This determined risk includes a time period for embers from the wildfire, the wildfire or both to reach the community, and can also include a time for the wildfire to pass by the community. The control system has information about the available amount of water to the community, and this information about the available amount of water includes a flow rate (F_{w}); and, and total volume of water (V_{w}). The time period for the determined risk of the wildfire to the community is defined as a time period (Tᵣ). The hydration plan includes the system delivering water to the area of the community of structures at one or more locations in the area. The delivery of water to the one or more locations being at one or more intervals (I) for each of the locations during the time period Tᵣ. Thus, the control system determines and implements the plan, such that each interval (i) has a predetermined duration defined by an interval time (Iₜ), and the delivery of water during each interval (I) is at a predetermined flow rate (IFᵣ). In this manner the hydration plan delivers a total volume of water (HV_{w}) during time period (Tᵣ); wherein IFᵣ does not exceed F_{w}, and HV_{w} does not exceed V_{w}. The development and implementation of the hydration plan maintains the structures, fuel sources in the community or both at an ignition point above the energy from an ember attack, the wildfire or both; thereby preventing ignition of the structures, the fuel sources in the community or both during the time period Tᵣ.

### Example 40A

In an embodiment of the automated adaptive hydration plan of Example 40, for the majority of intervals (I), and preferably all of the intervals (I), the interval time (Iₜ) is less than the time period Tᵣ. and, the total flow rate for all intervals (I) occurring at a same time does not exceed F_{w};

It is noted that there is no requirement to provide or address the theory underlying the novel and groundbreaking performance or other beneficial features and properties that are the subject of, or associated with, embodiments of the present inventions. Nevertheless, various theories are provided in this specification to further advance the art in this important area, and in particular in the important area of lasers, laser processing and laser applications. These theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the operation, function and features of embodiments of the methods, articles, materials, devices and system of the present inventions; and such later developed theories shall not limit the scope of protection afforded the present inventions.

The various embodiments of networks, systems for providing and displaying data and information set forth in this specification may be used in the above identified fields and in various other fields. Additionally, these embodiments, for example, may be used with: existing networks, emergency systems, social media systems, alert systems, broadcast systems, as well as other existing equipment; future systems and activities; and such items that may be modified, in-part, based on the teachings of this specification. Further, the various embodiments set forth in this specification may be used with each other in different and various combinations. Thus, for example, the configurations provided in the various embodiments of this specification may be used with each other. For example, the components of an embodiment having A, A′ and B and the components of an embodiment having A″, C and D can be used with each other in various combinations, e.g., A, C, D, and A. A″ C and D, etc., in accordance with the teaching of this Specification. The scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

What is claimed:

1. A coordinated wildfire management system for the protection of a community of structures, the system comprising:
a. a plurality of external fire management systems (EFMSs);
b. a plurality of structures; wherein the plurality of structures are located near one another and thereby define an area for the community of structures;
c. wherein more than half of the structures have an EFMS;
d. wherein the plurality of EFMSs are in control communication with a network;
e. a monitoring device in communication with the network; wherein the monitoring device can monitor a wildfire event and provide information about the wildfire event to the network;
f. a control system in control communication with the network, the control system comprises a graphic user interface, a processor and a memory device;
g. wherein each of the EFMSs is in control communication with the control system;
h. the control system comprising a hydration plan and configured to implement the hydration plan; wherein the hydration plan provides for using a minimum amount of water needed to protect the area from a wildfire threat; thereby preventing an ignition of the structures.

2. The system of claim 1, wherein the hydration plan comprises:
providing less than 1 inch of water per 24 hour period to a home ignition zone; wherein the home ignition zone is adjacent to at least one of the structures and extends out from the structure by about 5 feet to 30 feet.

3. The system of claim 2, wherein all of the structures in the plurality of structures has an EFMS and a water supply line; and wherein the EFMSs have an infeed line that provides a source of water from the water supply line.

4. The system of claim 3, wherein the EFMSs are not connected to, and do not use a municipal fire hydrant system as a source of water.

5. The system of claim 1, wherein the hydration plan comprises:
providing a sufficient amount of water over a predetermined time period to a home ignition zone to maintain a level of hydration in the home ignition zone at a fuel moisture content that is from about 100 percent to about 300% during the predetermined time period; wherein the home ignition zone is adjacent to at least one of the structures and extends out from the structure from about 5 feet to 30 feet.

6. The system of claim 1, wherein at least 90 percent of the structures in the plurality of structures has an EFMS.

7. The system of claim 1, further comprising: a sprinkler tower system; wherein the sprinkler tower system is located near a roadway in the community of structures and at least one of the structures in the community of structures; wherein the sprinkler tower system provides a zone of protection; whereby the zone of protection includes both a portion of the roadway and a portion of one or more of the structures; whereby the sprinkler tower system provides protection from wildfires to both the roadway, thereby providing a safe evaluation route, and to the portion of the structure.

8. The system of claim 1, further comprising a plurality of sprinkler tower systems; wherein the sprinkler tower systems are in control communication with the control system; and, delivery of water from the sprinkler tower systems is a part of the hydration plan.

9. The system of claim 8, wherein one or more of the EFMSs, the sprinkler tower system or both, have an additional water supply means.

10. The system of claim 9, wherein the additional water supply means comprises a pumper truck.

11. The system of claim 1, wherein the hydration plan comprises:
a. providing a sufficient amount of water over a predetermined time period to the area to maintain a level of hydration in the area at least 10% of a hydration level during the predetermined time period;
b. wherein the hydration level is based upon soil percentage water content by weight;
c. wherein the hydration level is defined as a level sufficient to maintain an ignition point of the structures, fuel sources in the community of structures or both above the energy from an ember attack, a wildfire or both; thereby preventing ignition of the structures, the fuel sources in the community of structures or both during the predetermined time period.

12. A coordinated wildfire management system for the protection of a community of structures, the system comprising:
a. a plurality of structures; wherein the plurality of structures are located near one another and thereby define an area for the community of structures;
b. wherein more than 75 percent of the structures have an external fire management systems (EFMSs);
c. a network comprising a monitoring and control system; wherein the monitoring and control system comprises a graphic user interface, a processor and a memory device;
d. wherein the EFMSs are in control communication with the monitoring and control system via the network; and,
e. the monitoring and control system is configured to:
i. determine a risk of a wildfire to the community of structures, thereby providing a determined risk of the wildfire to the community of structures;
ii. determine a hydration plan based upon the determined risk of the wildfire to the community of structures and an available amount of water for the system and thereby provide an automated adaptive hydration plan;
f. wherein the automated adaptive hydration plan provides for using no more than the available amount of water to protect the community of structures from the determined risk of the wildfire to the community of structures.

13. The system of claim 12, wherein the determined risk of the wildfire to the community of structures comprises a time period for embers from the wildfire, the wildfire or both to reach the community of structures.

14. The system of claim 13, wherein the time period further comprises a time for the wildfire to pass by the community of structures.

15. The system of claim 12, wherein:
a. the available amount of water is defined as:
i. a flow rate (F_{w}); and,
ii. and total volume of water (V_{w});
b. the determined risk of the wildfire to the community of structures includes a time period (Tᵣ); and
c. the hydration plan comprises:
i. the system delivering water to the area of the community of structures at one or more locations in the area;
ii. the delivery of water to the one or more locations being at one or more intervals (I) for each of the locations during the time period Tᵣ;
wherein each interval (i) has a predetermined duration defined by an interval time (Iₜ); and,
iii. the delivery of water during each interval (I) is at a predetermined flow rate (IFᵣ);
iv. whereby the hydration plan delivers a total volume of water (HV_{w}) during time period (Tᵣ);
d. wherein IFᵣ does not exceed F_{w}; and HV_{w} does not exceed V_{w};
e. thereby the structures, fuel sources in the community of structures or both are maintained at an ignition point above the energy from an ember attack, the wildfire or both; thereby preventing ignition of the structures, the fuel sources in the community of structures or both during the time period Tᵣ.

16. The system of claim 15, wherein time period Tᵣ comprises a time period for embers from the wildfire, the wildfire or both to reach the community of structures.

17. The system of claim 16, wherein the time period Tᵣ further comprises a time for the wildfire to pass by the community of structures.

18. The system of claim 15, wherein for at least the majority of intervals (I) the interval time (Iₜ) is less than the time period Tᵣ.

19. The system of claim 18, wherein a total flow rate for all intervals (I) occurring at a same time does not exceed F_{w}.

20. The system of claim 15, further comprising:
a. a plurality of sprinkler tower systems located in the area for the community of structures;
i. wherein one or more of the sprinkler tower systems is located near a roadway in the community of structures, an open space in the community of structures, or one of the structures;
ii. wherein two or more of the sprinkler tower systems is located near a roadway in the community and an open space in the community of structures;
iii. wherein two or more of the sprinkler tower systems is located near a roadway in the community of structures and a structure; or,
iv. wherein three or more of the sprinkler tower systems is located near a roadway in the community of structures, a structure and an open space in the community of structures;
b. wherein the sprinkler towers are in control communication with the network; and delivery of water from the sprinkler tower systems is a part of the hydration plan.
